(19) United States
(12) Patent Application Publication
(10) Pub. No.: US 2008/0074776 A1
(43) Pub. Date: Mar. 27, 2008

(54) Heat-assisted magnetic recording medium, and magnetic storage apparatus

(75) Inventor: Susumu Soeya, Tokyo (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/897,061

(22) Filed: Aug. 28, 2007

(30) Foreign Application Priority Data
Aug. 28, 2006 (JP) 2006-230616

(51) Int. Cl. G11B 5/02

(52) U.S. Cl. 360/59

(57) ABSTRACT

Embodiments of the present invention provide a heat-assisted magnetic recording medium capable of overcoming contradiction between the thermal fluctuation resistance at RT and easy writing at high temperature, capable of making the change of the coercive force to temperature change abrupt just below the recording temperature, and capable of formation at low temperature, specific anisotropy axis orientation and granulation. According to one embodiment, on a substrate, a magnetic exchange coupling film formed by successively stacking a lower layer antiferromagnet film at high K_{AF} of T_{B}<T_{W} and an upper layer ferromagnet film at high K_{F} of T_{W}<T_{C} as a write/read layer, comprising an antiferromagnet so as to satisfy a relations: T_{B}<<T_{N}, T_{B}<T_{C}<T_{N} and changing the coercive force to temperature characteristic stepwise at the temperature T_{B} just below T_{B} by utilizing the property of T_{B} and T_{B}<<T_{N} [T_{W}: recording temperature, T_{C}: curie temperature, T_{N}: Neel temperature, T_{B}: blocking temperature, K_{F}: crystal magnetic anisotropy energy constant of ferromagnet, K_{AF}: crystal magnetic anisotropy energy constant of the antiferromagnet.

### CROSS-REFERENCE TO RELATED APPLICATION

The instant nonprovisional patent application claims priority to Japanese Patent Application No. 2006-230616, filed Aug. 28, 2006 and which is incorporated by reference in its entirety herein for all purposes.

### BACKGROUND OF THE INVENTION

Along with improvement in the processing speed of computers in recent years, higher speed and higher density have always been required for a magnetic storage apparatus (HDD) serving for writing and reading functions of information and data. However, a physical limit is imposed on the increase of the density in current CoCrPt system media, which has become an issue.

For super high density magnetic recording, the volume of a magnetization reversal unit (substantially equal with magnetic particle) in a magnetic layer has to be decreased considerably. However, in a case of refining the magnetization reversal unit, the magnetic anisotropy energy possessed by the unit [(crystal magnetic anisotropy energy constant K_{F})×(volume V_{F} of magnetic particle), also referred to as (K_{F}V_{F}) product. F is an abbreviation for ferromagnet] decreases to less than the thermal fluctuation energy [(Boltzmann constant k_{B})×(temperature T)] and can no more retain a magnetic domain. This is a thermal fluctuation phenomenon which is mainly attributable to the physical limit of the recording density (also referred to as thermal fluctuation limit).

In order to prevent reversal of magnetization caused by thermal fluctuation, it may be considered to increase K_{F}. However, in a case of the HDD medium as described above, since the coercivity H_{C} is substantially in proportion to K_{F} upon conducting magnetization reversing operation (recording) at a high speed, it confronts a problem that recording cannot be conducted by a magnetic field that can be generated by a writing head (maximum: 10 kOe).

In order to solve the foregoing problems, an idea of a heat-assisted magnetic recording has been proposed, which is adapted to conduct magnetic recording by using a material of large K_{F} for a writing layer and heating the writing layer during recording to locally decrease K_{F} (that is, H_{C}), thereby conducting magnetic recording. In this system, even when K_{F} of the writing layer in the working circumstance of the medium (usually RT: room temperature) is large, magnetization reversion is possible under a recording magnetic field that can be generated by a current head.

However, since adjacent tracks are heated to some extent during recording, this may give undesired effects on the information in already recorded adjacent tracks or may cause a phenomenon that the thermal fluctuation is accelerated to erase recorded magnetic domain (close erasing). Further, since the medium is heated to some extent even at the instance where the head magnetic field disappears just after recording, the thermal fluctuation is also accelerated to possibly cause erasing of once formed magnetic domains. In order to solve such problems, it is necessary to use a material capable of making the change of K_{F} (that is, H_{C}) to the temperature in the vicinity of the recording temperature as abrupt as possible, that is, a material capable of abruptly increasing K_{F} (that is, H_{C}) at a recording temperature or lower. However, since the change of K_{F} (that is, H_{C}) in the current CoCrPt system to the temperature is substantially linear, the foregoing conditions cannot be satisfied.

For solving the problem, Japanese Patent Publication No. 2001-76331 (“patent document 1”) discloses a magnetic exchange coupling bi-layered medium constituted with a “functional layer (lower layer)/writing layer (upper layer)”. According to the publication, it is disclosed that the functional layer is constituted with an antiferromagnet (AF) having a Neel temperature (T_{N}) just below a recording temperature (T_{W}) (AF is an abbreviation for antiferromagnet). T_{N} is defined as a temperature at which magnetic exchange interaction in the AF layer (2 J_{AF}<S_{AF}><S_{AF}>, J_{AF}; exchange integration in AF layer, S_{AF}: AF spin < >: thermal average) is 0. [Curie temperature T_{C} is defined with a temperature at which the exchange interaction in the F layer (2J_{F}<S_{F}><S_{F}>, J_{F}: exchange integration in the F layer, S_{F}: F spin) is 0]. The writing layer is constituted, for example, with a ferromagnetic (F) layer such as of current CoCrPt system.

In the medium constituted with “functional layer/writing layer” described above, magnetic exchange coupling for “AF/F” is formed at RT. It is described that the value for K_{F} (that is, H_{C}) of the writing layer at RT can be increased to a large value since the magnetic exchange coupling is formed and it is described that the thermal fluctuation resistance is thereby increased. Further, it is described that the value of K_{F} (that is, H_{C}) for the writing layer abruptly lowers to a value for the writing layer single film at a temperature of T_{N} since it transits from the magnetic state of “AF/F” to the magnetic state of “Para./F” (Para. is an abbreviation for Paramagnetism) at a temperature T_{N}. That is, it is described that a large dK_{F}/dT or dH_{C}/dT is obtained at a temperature T_{N}. Further, it is disclosed that at the temperature T_{W}, since the value for K_{F} (that is, H_{C}) lowers as far as a value for the writing layer single film, the information can be written to a recording layer under a small recording magnetic field.

Also Japanese Patent Publication No. 2000-293802 (“patent document 2”) and Japanese Patent Publication No. 2002-358616 (“patent document 3”) describe that a large dH_{C}/dT is obtained at a blocking temperature T_{B} (≈T_{N}) and at a temperature T_{cE} (≈T_{N}) at a temperature where the exchange coupling interaction disappears or a large d(K_{F}V_{F})_{eff.}/dT [(K_{F}V_{F})_{eff.}: effective (K_{F}V_{F} value) of F film] is obtained.

Further, Appl. Phys. Lett., Vol. 82, pp. 2859-2861 (2003) discloses a magnetic film structure constituted with “FeRh (lower layer)/FePt (upper layer)”. The FeRh system material is the only material causing phase transition of: AF→F near 100° C. According to the article, it is described that H_{C} of the FePt film can be increased by magnetic exchange coupling for “AF/F” at RT. Further, it is described that since this transits from the magnetic state of “AF/F” to the magnetic state of “F/F” along with AF→F phase transition, the H_{C} value of the FePt film abruptly lowers to the value for the FePt single film near AF→F phase transition temperature (T_{AF/F}) of the FeRh film (near 100° C.). That is, it is described that a large dH_{C}/dT is obtained near the T_{AF/F} value of the FeRh film.

For realizing an HDD having an areal recording density that exceeds Tbit/in², it is necessary to realize a heat-assisted magnetic recording medium by overcoming the limit of the thermal fluctuation. For realizing a heat-assisted magnetic recording medium coping with superhigh density recording, it is necessary to realize:

(1) a medium capable of overcoming contradiction between the thermal fluctuation resistance at RT and easy writing at a high temperature (T_{W}) and

(2) a medium capable of making the change of H_{C} to the temperature abrupt just below T_{W}.

(3) In addition, it should be a medium capable of satisfying (a) formation at low temperature (b) specific anisotropy axis orientation [[111]axis orientation, c axis orientation, or a axis orientation], and (c) granulation. However, media capable of satisfying them have not been present so far.

In patent document 1 described above, utilizing T_{N} of the lower AF layer and changing the H_{C} to temperature characteristic to stepwise at the temperature T_{N} just below T_{W} is disposed. However, while the contradiction between the thermal fluctuation resistance at RT and easy writing at a high temperature T_{W} can be overcome, it seems that dH_{C}/dT just below T_{W} cannot be increased (cannot be made abrupt) sufficiently by the following reason.

At the temperature T_{N} of the AF layer, S_{AF} in the AF layer violently fluctuates thermally, <S_{AF}> disappears and, accordingly, an arrangement of AF spins having 2J_{AF}<S_{AF}><S_{AF}> also disappears. Accordingly, temperature dependence of <S_{AF}> (physical phenomenon that <S_{AF}> lowers in the manner of Brillouin function along with temperature increase and disappears at T_{N}) remarkably reflects from a temperature considerably lower than T_{N} on the temperature dependence K_{F} (that is, H_{C}) of the writing layer in the magnetic exchange coupling film of “AF/F” of the “functional layer/writing layer” described above and, actually, the H_{C} to temperature change just below T_{W} inevitably dulls. That is, dH_{C}/dT just below T_{W} cannot be increased by the utilization of T_{N} of the lower AF layer. Accordingly, it faces a problem incapable of solving problems such as undesired effects or cross erasing on adjacent tracks. Further, in a case of conducting heat-assisted magnetic recording by utilizing T_{N}, since magnetic exchange coupling occurs in a state where the thermal fluctuation of the AF spin in the AF layer is as large as it is, it may possibly cause a state incapable of conducting heat-assisted magnetic recording in the direction of the recording magnetic field.

In the same manner, patent documents 2 and 3 described above intend to obtain means for changing the H_{C} to temperature characteristic and the (K_{F}V_{F})_{eff} to temperature characteristic stepwise at a temperature: T_{B}≈T_{N} (it is disclosed that T_{B} is in a relation: T_{B}≈T_{N} and T_{B}<T_{N}<T_{C} and, more specifically, and it is recognized that it is in a relation: T_{B}<T_{N}<T_{W}<T_{C}) and at a temperature: T_{cE}≈T_{N} (it is disclosed that T_{cE} is in a relation: T_{cE}≈T_{N} and T_{cE}≈T_{N}<T_{C} and, more specifically, it is recognized that it is in a relation: T_{cE}≈T_{N}<T_{W}<T_{C}. However, since T_{B}≈T_{N} and T_{cE}≈T_{N}, this is actually identical with a case of intending to obtain dH_{C}/dT, and d(K_{F}V_{F})_{eff}/dT at temperature of T_{N}. Accordingly, it faces a problem of thermal fluctuation in the disappearing of <S_{AF}> and disappearing of AF spin arrangement having 2J_{AF}<S_{AF}><S_{AF}>, and dH_{C}/dT and d(K_{F}V_{F})_{eff}/dT at the temperature: T_{B}≈T_{N} and T_{cE}≈T_{N} are not actually abrupt. Accordingly, problems such as undesired effects or cross erasing on the adjacent tracks cannot be solved. Incidentally, AF materials capable of satisfying T_{B}=T_{N} and T_{cE}=T_{N} are only NiO and some γ-FeMn so long as the author knows. Most of γ-FeMn has a relation: T_{B}<T_{N}, T_{cE}<T_{N}. However, the difference is as small as about 62° C. Further, in a case of conducting heat assisted magnetic recording while utilizing T_{B}≈T_{N} or T_{cE}≈T_{N}, since magnetic exchange coupling is formed in a state where the thermal fluctuation of AF spins in the AF layer is large as it is, it may possibly cause a case incapable of conducting heat assisted magnetic recording in the direction of the recording magnetic field.

On the other hand, in the magnetic structural film constituted with “FeRh/FePt” described in Appl. Phys. Lett., Vol. 82, pp. 2859-2861 (2003), large <S_{AF}> remains in the FeRh film even just below AF→F phase transition temperature (T_{AF/F}) of the FeRh film and, accordingly, there is an arrangement of AF spins having larger 2J_{AF}<S_{AF}><S_{AF}>. Therefore, H_{C} to temperature change just below the T_{AF/}F value of the FeRh film can be made abrupt and problems such as undesired effects or close erasing on the adjacent tracks described above can be avoided. However, since FeRh is an ordered alloy, and the temperature of a heat treatment necessary for ordering (disorder/order phase transformation) is as high as 550° C., practical use becomes unsuitable.

### BRIEF SUMMARY OF THE INVENTION

Embodiments in accordance with the present invention provide a heat-assisted magnetic recording medium capable of overcoming contradiction between the thermal fluctuation resistance at RT and easy writing at high temperature, capable of making the change of the coercive force to temperature change abrupt just below the recording temperature, and capable of formation at low temperature, specific anisotropy axis orientation and granulation. According to the particular embodiment disclosed in FIG. 1, on a substrate, a magnetic exchange coupling film formed by successively stacking a lower layer antiferromagnet film 300 at high K_{AF} of T_{B}<T_{W} and an upper layer ferromagnet film 400 at high K_{F} of T_{W}<T_{C} as a write/read layer, comprising an antiferromagnet so as to satisfy a relations: T_{B<<T}_{N}, T_{B}<T_{C}<T_{N} and changing the coercive force to temperature characteristic stepwise at the temperature T_{B} just below T_{B} by utilizing the property of T_{B} and T_{B}<<T_{N}[T_{W}: recording temperature, T_{C}: curie temperature, T_{N}: Neel temperature, T_{B}: blocking temperature, K_{F}: crystal magnetic anisotropy energy constant of ferromagnet, K_{AF}: crystal magnetic anisotropy energy constant of the antiferromagnet.

### BRIEF DESCRIPTION OF THE DRAWINGS

FIG. 1 is an enlarged cross sectional view of a magnetic exchange coupling bi-layered medium for heat-assisted magnetic recording constituted with a lower layer antiferromagnetic film/upper layer ferromagnetic film for writing and reading according to an embodiment of the invention.

FIGS. 2(a) and 2(b) are views showing the temperature dependence of the effective (K_{F}V_{F})/k_{B}T value: (K_{F}V_{F})_{eff.}/k_{B}T value of the upper layer ferromagnetic film for writing and reading in the magnetic exchange coupling bi-layered medium for use in heat-assisted magnetic recording.

FIG. 3 is a view showing the dependence of the order parameter (S) of a FePt film on the heat treatment temperature.

FIGS. 4(a) and 4(b) are views showing an X-ray diffraction profile for a Ta/Cu/L1₀PtMn/L1₀FePt film.

FIG. 5 is a view showing a transmission TEM photograph for an L1₀FePt film.

FIGS. 6(a)-6(d) are views showing the state of hysteresis of spin arrangement during heat-assisted magnetic recording to a magnetic exchange coupling bi-layered medium for use in heat-assisted magnetic recording according to an embodiment of the invention.

FIG. 7 is a view showing a state of magnetization vectors after recording for [111] axis oriented magnetic exchange coupling bi-layered medium (tilted magnetic anisotropy medium) according to an embodiment of the invention.

FIG. 8 is an explanatory view of crystal structure—magnetic structure of L1₀FePt.

FIG. 9 is an explanatory view of a crystal structure—magnetic structure of L1₀PtMn.

FIG. 10 is an explanatory view for crystal lattice—magnetic structure in the (111) face of L1₀PtMn/L1₀FePt film.

FIG. 11 is a view showing a relation of T_{B} and T_{N} to Au addition amount in an L1₀(Pt_{50-X}Auₓ)Mn₅₀ (in atomic %) film.

FIG. 12 is a view showing a relation of T_{C} to Ni addition amount in an L1₀(Fe_{50-X}Niₓ)Pt₅₀ (in atomic %) film.

FIG. 13 is an enlarged cross sectional view of a magnetic exchange coupling bi-layered medium for use in heat-assisted magnetic recording constituted with all L1₀PtMn—Au antiferromagnet (lower layer)/L1₀FePt—Ni:Ag ferromagnetic layer for writing and reading (upper layer).

FIG. 14 is a view showing the dependence of coercivity (H_{C}) of L1₀FePt—Ni:Ag for writing and reading in the magnetic exchange coupling bi-layered medium for use in heat-assisted magnetic recording in FIG. 13.

FIG. 15 is a view showing a relation of T_{B} and T_{N} to a Pd addition amount in all L1₀(Pt_{50-X}Pdₓ)Mn₅₀ (in atomic %) film.

FIG. 16 is a view showing a relation of T_{B} and T_{N} to the Rh addition amount in an L1₀(Pt_{50-X}Rhₓ)Mn₅₀ (in atomic %) film.

FIG. 17 is a schematic view showing a magnetic disk apparatus using a heat-assisted magnetic recording medium according to an embodiment of the invention.

FIG. 18 is a view showing an example of a magnetic head.

### DETAILED DESCRIPTION OF THE INVENTION

Embodiments in accordance with the present invention concern a heat-assisted magnetic recording medium, and a magnetic storage apparatus (HDD).

In view of the background set forth above, an object of embodiments in accordance with the present invention is to realize a heat-assisted magnetic recording medium capable of simultaneously satisfying three conditions:

(1) capable of overcoming contradiction between the thermal fluctuation resistance at RT and easy writing at high temperature (T_{W}),

(2) capable of making the H_{C} to temperature change abrupt just below T_{W},

(3) (a) formation at low temperature, (b) specific anisotropy axial orientation [[111]axis orientation, c axis orientation, or a axis orientation], and (c) granulation.

The foregoing objects (1) and (2) can be attained by having, on a substrate, 0.1 magnetic exchange coupling film formed by stacking a lower layer film comprising an antiferromagnet at high K_{AF} of T_{B}<T_{W} and an upper layer film comprising a ferromagnet at high K_{F} of T_{W}<T_{C} as a write/read layer, constituting the antiferromagnet so as to satisfy a relations: T_{B}<<T_{N}, T_{B}<T_{C}<T_{N} (more specifically, T_{B}<T_{W}<T_{C}<T_{N}) and changing the H_{C} to temperature characteristic stepwise at the temperature T_{B} just below T_{W} by utilizing the property of T_{B} and T_{B}<<T_{N}, assuming T_{W} as a recording temperature, T_{C} as a curie temperature, T_{N} as a Neel temperature, T_{B} as a blocking temperature, K_{AF} as crystal magnetic anisotropy energy constant of the ferromagnet, and K_{AF} as crystal magnetic anisotropy energy constant of an antiferromagnet.

T_{B} is defined as:

(a) a temperature at which the magnetic exchange interaction at the AF/F interface (2J_{AF/F}<S_{AF}><S_{F}>, J_{AF/F}: exchange integration at AF/F interface) becomes 0, or

(b) a temperature at which the (K_{AF}V_{AF}) product lowers along with temperature increase but the (K_{AF}V_{AF}) value starts to be decreased from the 2J_{AF/F}<S_{AF}><S_{F}> value. In a case of metal/metal “AF/F” magnetic exchange coupling, T_{B} is determined by the latter in most material systems. Anyway, T_{B} is different from T_{N}: temperature at which 2J_{AF}<S_{AF}><S_{AF}> becomes 0 and T_{C}: temperature at which 2J_{F}<S_{F}><S_{F}> becomes 0 described above. Further, it is to be emphasized that the medium of the invention has a property of: T_{B}<T_{N}. With an engineering point of view, T_{B} is substantially determined by the physical property on the side of the AF layer. It is estimated that since the Curie temperature of the making F layer (Fe system, Co system, etc.) is extremely high, T_{B} seems to be determined by the physical property on the side of the AF layer, but details thereof have not yet been apparent. As described above, T_{B} is determined depending on the antiferromagnetic material and does not depend so much on the ferromagnetic material. Accordingly, in the present specification, expression as “T_{B} of AF film or T_{B} of PtMn film” is used. In a case of (K_{AF}V_{AF}) product >(2J_{AF/F}<S_{AF}><S_{F}>)>(K_{F}V_{F}) product: magnetic exchange coupling where a magnetization curve shifts in the direction occurs, and

In a case: (K_{F}V_{F}) product >(K_{AF}V_{AF}) product >(2J_{AF/F}<S_{AF}><S_{F}>): since the crystal magnetic anisotropy energy of the F film is strong, bidirectional anisotropy is caused in the material system having magnetic anisotropy of twice rotation symmetry as in L1₀FePt, which reflects on the magnetization curve to cause H_{C} increasing magnetic exchange coupling.

The object (3) can be attained by (a) temperature lowering: Ar discharge cleaning method, high Ar pressure sputtering film deposition, (b) for example, [111] axis orientation: arrangement of Ta/Cu(111) seed layer, (c) granulation: self-assembled method by high Ar pressure sputtering film deposition, and addition of Ag, Bi, Sb, Sn or Pb not solid solubilizable with the L1₀ phase.

Further, it can be recognized from patent documents 1, 2, and 3 that the magnetic state of magnetic exchange coupling bi-layered medium at T=T_{W} is “para. (lower layer)/F(upper layer)”. On the other hand, the magnetic state of the magnetic exchange coupling bi-layered medium at T=T_{W} according to embodiments of the invention is “AF(lower layer/Para. (inter-face)/F (upper layer)” as will be described later in detail. It is one of the differences that thermal magnetic recording is conducted in the magnetic state of “Para./F” in the known art described above and in the magnetic state of “AF/Para (interface)/F” according to embodiments of the invention.

By using the magnetic recording medium according to embodiments of the invention, it is possible to provide a heat-assisted magnetic recording medium capable of simultaneously satisfying three conditions:

(1) capable of overcoming contradiction between the thermal fluctuation resistance at RT and easy writing at a high temperature (T_{W}),

(2) capable of making the change of H_{C} to the temperature abrupt just below T_{W}, and

(3) (a) formation at low temperature, (b) specific anisotropy axial orientation [[111]axis orientation, c axis orientation, or a axis orientation], and (c) granulation. Accordingly, this can overcome the limit (thermal fluctuation limit) for recording density that the current perpendicular magnetic recording media such as CoCrPt—SiO₂ is to be faced. Further, since the write/read layer can maintain extremely high thermal fluctuation resistance and high coercivity within a temperature range of RT to T_{B} just below T_{W}, even when adjacent tracks are heated to some extent along with increase of the temperature in a trailing area during heat-assisted recording, the adjacent tracks suffer from no undesired effects and the problem of close erasing can also be avoided. Accordingly, a heat-assisted magnetic recording medium capable of coping with recording density exceeding Tbit/in² and an HDD apparatus can be provided.

Typical examples of the present invention are to be described below with reference to the drawings.

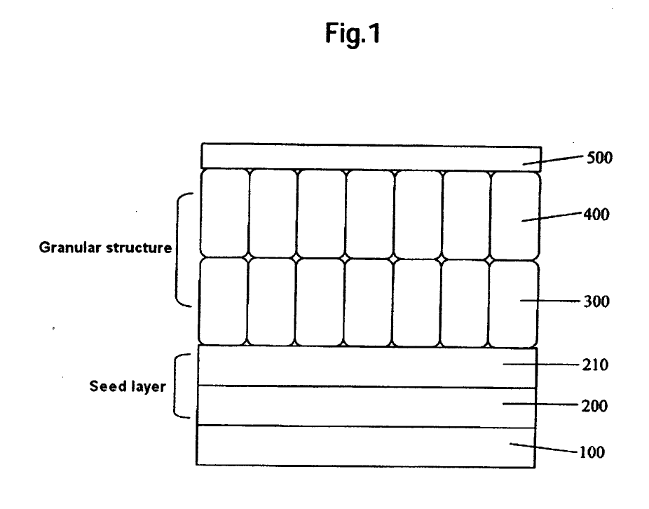

FIG. 1 shows a magnetic exchange coupling bi-layered medium for use in heat-assisted magnetic recording according to the invention. The medium has, on a substrate 100, layers formed by successively stacking an underlayer film 200, a heat sink layer 210, an underlayer film 300 comprising an antiferromagnet (AF) at high K_{AF} of T_{B}<T_{W}, an upper layer film 400 comprising a ferromagnet (F) at high K_{F} of T_{B}<T_{C} as a write/read layer, and a protective film 500. The antiferromagnet is constituted so as to satisfy the relation: T_{B}<<T_{N}, T_{B}<T_{C}<T_{N}. T_{W}: recording temperature, T_{C}: Curie temperature, T_{N}: Neel temperature, T_{B}: blocking temperature, K_{F}: crystal magnetic anisotropy energy constant of ferromagnet, K_{AF}: crystal magnetic anisotropy energy constant of antiferromagnet.

The substrate 100 comprises, for example, a glass substrate, the underlayer film 200 comprises, for example, a Ta film, the heat sink layer 210 has, for example, an Fcc structure and comprises a Cu film of excellent heat conductivity (specific resistivity ρ≦25 μΩcm), the under layer AF film 300 comprises, for example, an L1₀PtMn film, the upper layer F film 400 comprises, for example, an L1₀FePt film, and the protective film 500 comprises, for example, a C film. The Ta seed layer/Cu heat sink layer also serves as a seed layer for the L1₀PtMn/L1₀FePt layer thereabove. In a case of low temperature formation, crystal orientation of amorphous Ta/Cu(111)/L1₀PtMn(111)/L1₀FePt(111) as a dense surface for each layer is obtained to form a (111) oriented film. Typical film thickness is 5 nm for the underlayer film 200, 30 nm for the heat sink layer 210, 12.5 nm for the lower layer AF film 300, 2.5 nm for the upper layer F film 400, and 3 nm for the protective film 500. Further, the L1₀PtMn(111)/L1₀FePt(111) film on the Ta/Cu(111) seed layer has a granular structure and the typical grain size is 10 nm. Since T_{B} of the L1₀PtMn film is about 320° C., T_{C} of the L1₀FePt is about 470° C., and T_{N} of the L1₀PtMn film is about 700° C., the L1₀PtMn film satisfies the relations: T_{B}<<T_{N}, and T_{B}<T_{C}<T_{N} described above.

The intrusion depth of a laser light or near-field light used in heat-assisted magnetic recording to the inside of the film is about 30 nm. Further, in order that the L1₀PtMn film shows antiferromagnetism, a film thickness of 12 nm or more is necessary. Further, the protective film of about 3 nm is necessary for the uppermost layer as described above. From the foregoing, since the maximum film thickness of the L1₀FePt film has to satisfy the relation (intrusion depth of laser light/near-field light to the inside of the film of 30 nm-protective film of 3 nm-necessary minimum film thickness of L1₀PtMn of 12 nm), it is about 15 nm. On the other hand, in a case where the thickness of the L1₀FePt film is made excessively thin, it cannot be a ferromagnet but becomes a superparamagnet. Considering the above, the thickness of the L1₀FePt film has to be within a range of about 1.3 to 15 nm. Since the thickness of the L1₀PtMn film on one side has to satisfy a relation (intrusion depth of laser light/near-field light to the inside of the film of 30 nm-protective film of 3 nm-L1₀FePt film thickness of 1.3 to 15 nm), it should be within a range of about 12 to 25.7 nm.

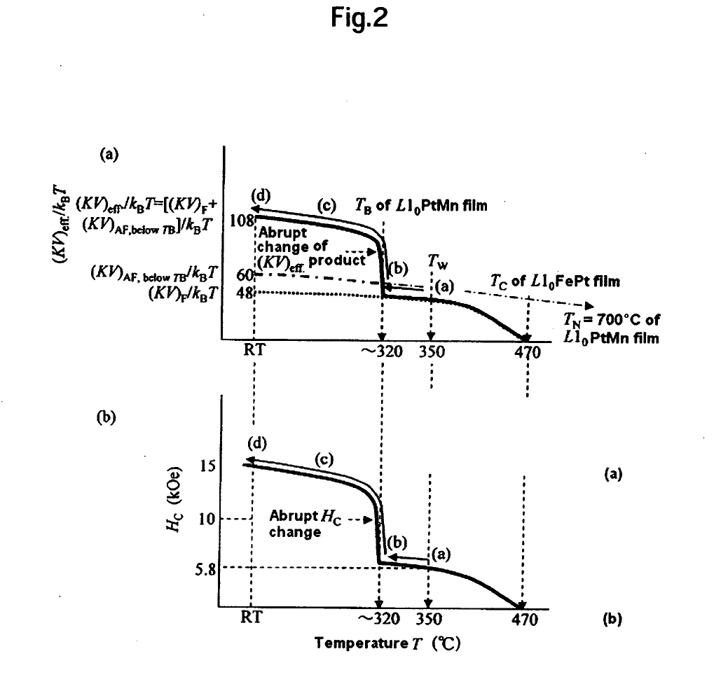

FIG. 2(a) shows the temperature dependence of the effective (KV)/(k_{B}T) value: (K_{F}V_{F})_{eff.}/k_{B}T) value of the upper layer F film in the magnetic exchange coupling bi-layered medium for use in heat-assisted magnetic recording medium according to the invention. It shows a relation of (K_{F}V_{F})_{eff.}/k_{B}T) value to temperature in a case where the lower layer AF film 300 comprises L1₀PtMn film of 12.5 nm thickness, the upper layer F film 400 comprises L1₀Pt film of 2.5 nm thickness, and the grain size of L1₀PtMn/L1₀FePt is 10 nm. The Kit value of the L1₀FePt film and the K_{AF} value of the L1₀PtMn film necessary for the calculation of the (K_{F}V_{F})_{eff.}/k_{B}T) value are set to 10₇ erg/cm³ and 2.5×10⁶ erg/cm³, respectively while considering the factor for the dirtiness inherent to materials (such as lattice defects or involvement of impurities due to low temperature formation).

The (K_{F}V_{F})_{eff.}/k_{B}T) value at RT of the upper layer F film 400 showed an extremely large value of about 108 due to the “AF/F” magnetic exchange coupling of the two layers of “underlayer AF film 300/upperlayer F film 400”. Since the (K_{F}V_{F})/(k_{B}T) value at RT of the L1₀FePt single layer film was about 48, it has been found that it was increased to an extremely large value by the superposition of the large (K_{AF}V_{AF})/(k_{B}T) value of about 60 (RT) of the L1₀PtMn film by “AF/F” magnetic exchange coupling. Further, it has been found that the large (K_{F}V_{F})_{eff.}/(k_{B}T) value is maintained in a temperature range of: RT to T_{B}. The hysteresis of (KV)_{eff}/k_{B}T during heat-assisted recording is: (a)→(b)→(c)→(d) as shown in the drawing.

FIG. 2(b) shows an H_{C} to temperature relation of the upper layer F film in the magnetic exchange coupling bi-layered medium for use in heat-assisted magnetic recording according to the invention. The H_{C} value at RT of the upper F film 400 showed a large value of about 15 kOe by “AF/F” magnetic exchange coupling of the two layers of “under layer AF film 300/upper layer F film 400”. Since the H_{C} value of the L1₀FePt single layer film RT was about 8 kOe, it has been found that it is increased to a large value by the “AF/F” magnetic exchange coupling and can exceed the maximum magnetic field of 10 kOe of the recording head. Further, the large H_{C} value at RT of the upper layer F film 400 gradually decreased in the manner of the Brillouin function along with temperature increase, decreased abruptly at about 320° C. as the T_{B} value of the lower layer AF film 300 (L1₀PtMn film) and just below: T_{W}=350° C. (temperature at which “AF/F” magnetic exchange coupling disappears) and then showed an H_{C} value in accordance with the temperature dependence of H_{C} of the upper layer F single layered film. In FIG. 2(b), it is to be emphasized that the change of the H_{C} value to the temperature (that is, dH_{C}/dT) is extremely abrupt (stepwise or stair-like) near the T_{B} value and just below the T_{W} value. Further, the H_{C} value of the upper-layer F film 400 near: T_{W}=350° C. was about 5.8 kOe. Since the maximum recording magnetic field of a current head is as high as about 10 kOe, writing (recording) to the upper layer F film 400 where the H_{C} value lowered as far as about 5.8 kOe near T_{W}≈350° C. is easy. The hysteresis of H_{C} during heat-assisted recording is (a)→(b)→(c)→(d) as shown in the drawing.

The reason why explanation has been made while selecting T≈350° C. is as described below. That is:

because it is necessary to set T_{W} to 320° C. or higher since actually measured T_{B} value of L1₀PtMn was about 320° C.,

on the other hand, because the medium is deteriorated by heat irradiation, over and over in a case where T_{W} is made excessively high, and because it is estimated that the maximum recording temperature capable of preventing the deterioration of the medium by the heat irradiation is about 350° C. It is desired to further restrict T_{W} somewhat lower for preventing the degradation of the medium due to heat irradiation and the method therefor, etc. are mentioned in Example 2.

As described above, it has been found that an extremely high thermal fluctuation resistance and high H_{C} value can be obtained within a temperature range of RT to T_{B} by “AF/F” magnetic exchange coupling of the two layers of “lower layer AF film 300/upper layer F film 400”. Further, it has been found that the contradiction to easy writing at a high temperature (T_{W}) can be overcome. Further, it has been found that the change of the H_{C} value to temperature near the T_{B} value and just below T_{W} can be made abrupt. That is, it has been found that a large dH_{C}/dT can be obtained.

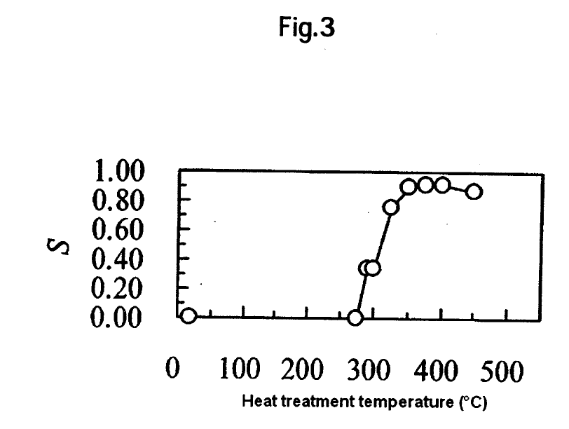

FIG. 3 shows a relation of an order parameter (S) of the FePt film to the heat treatment temperature according to an embodiment of the invention. S is a physical parameter showing the degree of ordering. This is a relation of S to heat treatment temperature for the film obtained by conducting a pretreatment of Ar discharge cleaning before deposition of the FePt film and then depositing the FePt film by sputtering under a high Ar gas pressure condition. The film deposition temperature is at RT and the heat treatment time at each temperature is 0.5 h. It can be confirmed that S increases at a heat treatment temperature of 275° C. or higher and a value of about 0.9 is obtained at 350° C. or higher. It can be seen from this that the ordering temperature of the FePt film is about 350° C. and since this is about at the same level as the maximum heating temperature of a current medium, it can be said that there is no practical problem. That is, low temperature formation is possible.

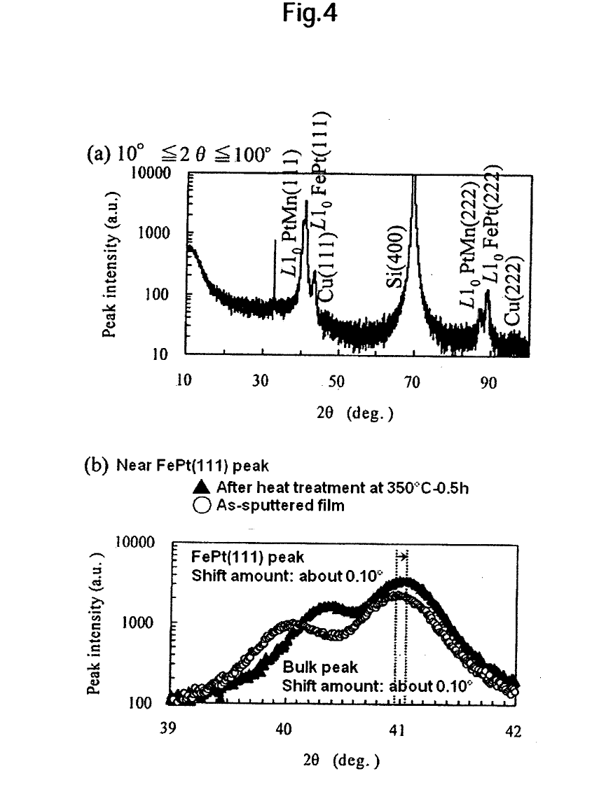

FIG. 4(a) is an X-ray diffraction profile for a Ta/Cu/L1₀PtMn/L1₀FePt film according to an embodiment of the invention. This is an X-ray diffraction profile after a heat treatment at 350° C. for 0.5 h after film deposition at RT. For X-ray diffraction, a sample deposited on a thermally oxidized silicon substrate was used. It can be confirmed that each of the Ta/Cu(111) seed layer, the L1₀PtMn film, and the L1₀FePt film is oriented only in the (111) direction.

As shown in FIG. 4(b), since the peak shift amount of about 0.1° of FePt(111) after a heat treatment at 350° C. for 0.5 h agreed with the peak shift amount of about 0.1 accompanying the disorder/order phase transformation of bulk FePt, it has been judged that the peak near 2θ≈41° is an L1₀FePt(111) peak.

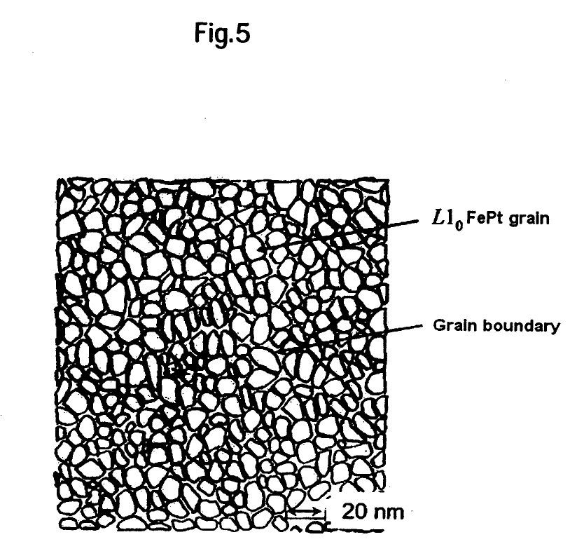

FIG. 5 is a transmission TEM photograph for an L1₀FePt film according to an embodiment of the invention. This is a transmission TEM photograph for the L1₀FePt film obtained by sputtering deposition of the FePt film under a high Ar gas pressure condition. It can be confirmed that the grain size was about 10 nm and it has a granulated structure. That is, the granulated structure could be obtained only by the self assembled method by high Ar pressure sputtering deposition. In a case where granulation is insufficient, the granulation can be promoted by adding, as a third element, Ag, Sn, Pb, Sb, Bi, etc. which are not solid solubilizable with L1₀FePt. Since also the L1₀PtMn film is deposited by sputtering under a high Ar gas pressure condition, it is considered that also L1₀PtMn has a granulated structure. In fact, it had a granulated structure according to the former experiment in another field (GMR film).

As described above, a solution can be given by temperature lowering in the deposition process: Ar discharge cleaning, high Ar pressure sputtering deposition, orientation on specific anisotropy axis ([111]axis orientation): arrangement of the Ta/Cu (111) seed layer, granulation: self assembled method by high Ar pressure sputtering deposition, and addition of Ag, Sn, Pb, Sb, and Bi as elements not solid solubilizable with L1₀FePt.

Accordingly, by using “AF/F” magnetic exchange coupling bi-layered medium of two layers of “under layer AF film 300/upper layer F film 400” shown in Example 1, it is possible to realize a heat-assisted magnetic recording medium capable of simultaneously satisfying three factors:

(1) capable of overcoming contradiction between the thermal fluctuation resistance at RT and easy writing at high temperature (T_{W}) and

(2) capable of making the H_{C} to temperature change abrupt just below T_{W},

(3) (a) formation at low temperature (b) specific anisotropy axial orientation [[111]axis orientation), and (c) granulation.

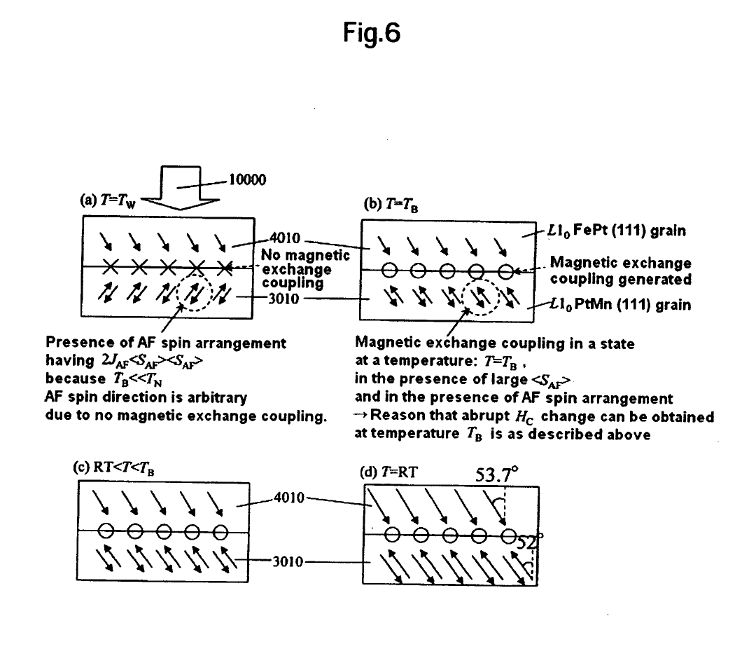

Then, the heat-assisted magnetic recording process to a magnetic coupling bi-layered medium constituted with “under layer AF film 300/upper layer F film 400” according to an embodiment of the invention is to be described. FIG. 6 shows the state of thermal hysteresis for the spin arrangement during heat-assisted magnetic recording in one “AF/F” magnetic exchange coupling crystal grain constituted with “one crystal grain 3010 of the lower layer AF film/one crystal grain 4010 of the upper layer F film”. While the state in one crystal grain is drawn, the state in one magnetization reversal unit is also identical. This is to be described herein to a case in which the lower layer AF film 300 and one crystal grain 3010 of the lower layer AF film comprise L1₀PtMn [orientation property: (111) orientation], the upper layer F film 400, and one crystal grain 4010 of the upper layer F film comprise L1₀FePt [orientation property: (111 orientation)]. T_{N} of the L1₀PtMn film is about 700° C., T_{C} of the L1₀FePt film is about 470° C., and the actually measured value T_{B} of the L1₀PtMn film is about 320° C. Description is to be made below while assuming as: T_{W}≈350° C.

As shown in FIG. 6(a), it is assumed that heat and recording magnetic field 10,000 are irradiated and applied at T=T_{W} downward from above the medium. Since T_{N} of the L1₀PtMn film is about 700° C. and T_{C} of the L1₀FePt film is about 470° C. and each of them is higher than T_{W}=350° C., the magnetic state in one crystal grains constituted with “one crystal grain 3010 of the lower layer AF film/one crystal grain 4010 of the upper layer F film” is “AF/F”. However, since T_{B} of the L1₀PtMn film is about 320° C., the magnetic state is described more specifically as: “AF/Para.(interface)/F” (Para.: abbreviation for paramagnetism). Accordingly, at T=T_{W}, the magnetization vector in one crystal grain 4010 of the upper layer F film is easily directed downward because of the low H_{C} of L1₀FePt [5.8 kOe, FIG. 2(b)]. More specifically, since the axis of easy magnetization ([002] axis, that is, c axis) is tilted by 53 to 54° from the direction perpendicular to plane ([111] axis), it is directed downward in a state of maintaining the tilt angle. However, since this is a state with no magnetic exchange coupling, the direction of arrangement of AF spins in one crystal grain 3010 of the lower layer AF film is optional.

As has been described above, the T_{B} value is determined by the antiferromagnetic material but does not depend so much on the ferromagnetic material. Accordingly, expression: “T_{B} of AF film or T_{B} of PtMn film” is used in the present specification.

As shown in FIG. 6(b), when it is cooled to T=T_{B}, magnetic exchange: coupling occurs. Correspondingly, the magnetic state in one crystal grain constituted with “one crystal grain 3010 of the lower layer AF film/one crystal grain 4010 of the upper layer F film” transits as “AF/Para. (interface)/F”<“AF/F”. Spins at each of the layers and each of interfaces are aligned so as to direct the spins in one crystal grain 4010 of the upper layer F film downward, and field-cooled and frozen. It is said that the internal magnetic field generated by magnetic exchange coupling is as high as several hundreds of kOe, and AF spins in one crystal grain 3010 of the lower layer AF film are aligned, for example, as shown in FIG. 6(b) being subdued by the large magnetic field. More specifically, since the axis of the easy magnetization ([002] axis, that is, c-axis) of L1₀PtMn is tilted by about 52° from the direction perpendicular to the plane ([111] axis), they are aligned as shown in FIG. 6(b) in a state of maintaining the tilt angle. However, since K_{F} of L1₀FePt is extremely large, it is considered that the tilt angle of the axis of easy magnetization of L1₀PtMn from the in-plane direction is from 53 to 54°, which is identical with that for L1₀FePt.

Further, due to “property of T_{B}<<T_{N}”, there exists a relatively large <S_{AF}> in one crystal grain 3010 of the lower layer AF film already at the instance cooled to: T=T_{B} and, accordingly, AF spin arrangement having relatively large 2J_{AF}<S_{AF}><S_{AF}> (S_{AF}: AF spin, < >: thermal average, J_{AF}: exchange integration in AF layer). Since “AF/F” magnetic exchange coupling is formed suddenly at the instance it is cooled to T=T_{B} in a state where relatively large <S_{AF}> and 2J_{AF}<S_{AF}><S_{AF}> are present, H_{C} suddenly (stepwise) increases at temperature: T=T_{B}. This is a reason why the H_{C} to temperature change can be made abrupt at a temperature: T=T_{B} and it is to be emphasized that this is a physical phenomenon which is obtainable only when the “property of T_{B}<<T_{N}” is utilized. That is, this is the physical phenomenon not obtainable by the utilization of T_{N} (<T_{C}) described in patent document 1, utilization of T_{B}≈T_{N} (<T_{C}) described in patent document 2, and utilization of T_{cE}≈T_{N} (<T_{C}) described in patent document 3 described already. Further, it is emphasized here that quite different physical phenomena are utilized in the physical means of utilizing the magnetization transition of: “AF (lower layer/Para. (interface)/F (upper layer)” (T>T_{B})→“AF/F” (T≦T_{B}) thereby, making dH_{C}/dT larger and in the physical means of utilizing the magnetization transition of: “F (FeRh, lower layer)/F (FePt, upper layer)” (T>T_{AF/F})→“AF/F” (T≦T_{AF/F}), that is, utilizing the primary phase transfer of FeRh ferromagnetic phase (T>T_{AF/F}) having relatively large <S_{F}> and 2J<S_{F}><S_{F}>(T>T_{AF/F})→FeRh antiferromagnetic phase having relatively large <S_{AF}> and 2J_{AF}<S_{AF}><S_{AF}(T<T_{AF/F}) in a state of providing a relatively large <S>(S: spin, J_{F}: magnetic exchange integration in F layer, < >: thermal average, S_{F}: F spin), thereby making dH_{C}/dT larger described in Appl. Phys. Lett., Vol. 82, pp. 2859-2861 (2003) as described already. The mechanism for making dH_{C}/dT larger is to be simply summarized as below.

Embodiments in accordance with the present invention: a large dH_{C}/dT is obtained at a temperature T_{B} by utilizing the property of T_{B} and “T_{B}<<T_{N}” of the AF film and magnetically exchange coupling the lower layer AF film in a state of providing large <S_{AF}> at a temperature T_{B} with upper layer F film. Referring specifically for the magnetic state of the magnetic exchange coupling bi-layered film, “AF/Para. (interface)/F” (T>T_{B})→“AF/frustration magnetic property (interface)/F” (T≦T_{B}). It is a significant feature that the magnetic exchange coupling is not present between the lower layer AF film and the upper layer F film at T>T_{B}, while “AF/F” magnetic exchange coupling is suddenly caused in a state of providing the lower layer AF film with large <S_{AF}> at a temperature T_{B}.

Appl. Phys. Lett., Vol. 82, pp. 2859-2861 (2003): since the lower layer FeRh film suddenly changes as: <S_{F}>→<S_{AF}> in a state of maintaining a large <S> by utilizing T_{AF/F} of the FeRh film at a temperature T_{AF/F}, it is put to magnetic coupling with the upper layer F film in a state of providing the lower layer FeRh film with large <S_{AF}>, to obtain a large dH_{C}/dT at a temperature T_{AF/F}. The magnetic state of the magnetic coupling bi-layered film is specifically referred to as: “F/(F+frustration magnetism)(interface)/F” (T>T_{AF/F})→“AF/(frustration magnetism)(interface)/F” (T≦T_{AF/F}). It is a significant feature that the lower layer FeRh film and the upper layer FePt film form “F/F” magnetic exchange coupling at: T>T_{AF/F}, which is suddenly changed to “AF/F” magnetic exchange coupling in a state of providing the lower FeRh film with a large <S_{AF}> at a temperature T_{AF/F}.

However, as has been described already, while a large dH_{C}/dT is obtained also by the method as described in Appl. Phys. Lett., Vol. 82, pp. 2859-2861 (2003), since FeRh is an ordered alloy and a temperature of a heat treatment necessary for ordering (disorder/order phase transformation) is as high as 550° C., the FeRh system film is not suitable to practical use.

As shown in FIG. 6(c), when it is cooled to: RT<T<T_{B}, magnetization vectors in respective layers increase and they are further increased and fixed at: T=RT as shown in FIG. 6(d). The foregoing are the process of heat-assisted magnetic recording. For the upward recording process, it may be considered while reversing the magnetization vectors described above.

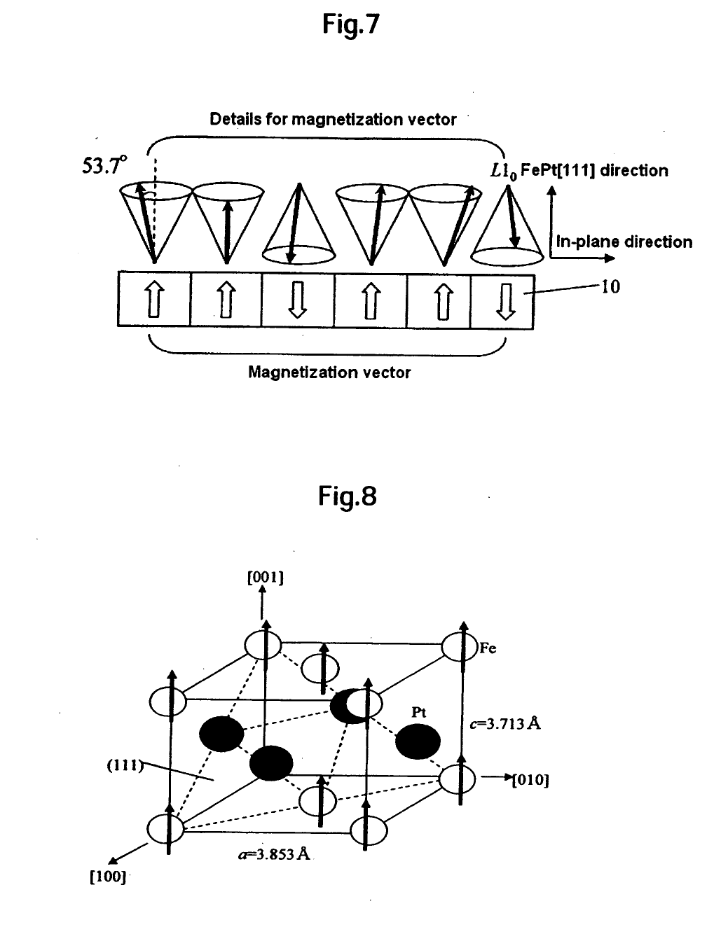

FIG. 7 expresses the direction of magnetization vectors after recording for a [111]axis oriented magnetic exchange coupling bi-layered medium according to an embodiment of the invention, that is, a tilted magnetic anisotropy magnetic exchange coupling bi-layered medium. Since K_{F} of L1₀FePt is extremely large and since the axis of easy magnetization ([002]axis, that is, c-axis) of L1₀FePt is tilted by 53 to 54° from the direction perpendicular to plane ([111] axis), recording is conducted in a state of tilting the axis by 53 to 54° from the direction perpendicular to the plane. Further, since this is polycrystal, recording is conducted for:

one magnetization reversal unit: such that magnetization vector is directed from the top on a cone to an appropriate point on an arc and for

entirely in-plane direction: such that the end point of the magnetization vector rotates uniformly in 360° plane along the arcuate shape. Further, even when recording is conducted such that the end point of the magnetization vector rotates uniformly in a 360° plane along the arcuate shape as described above, there is no problem and writing and reading can be conducted in the same manner as in the existent magnetic recording. Further, in a case of the [111]axis oriented magnetic exchange coupling bi-layered medium, since the anisotropy axis is tilted by about 53 to 54° from the direction perpendicular to the plane, it also provides an effect capable of decreasing a necessary recording magnetic field by about 30% compared with the perpendicular magnetization film (c-axis oriented film).

It is to be simply described here that the lower layer AF film 300 according to an embodiment of the invention consists only of the L1₀PtMn system.

For the lower layer AF film 300, since it is necessary to superpose a large (K_{AF}V_{AF}) product on the upper layer F film 400 (L1₀FePt system), high K_{AF} is demanded for the lower layer AF film 300. It can be said without exaggeration that only the L1₀PtMn system film constitutes the AF film having high K_{AF}. It is estimated that since the L1₀PtMn system film has a large lattice distortion and since Pt has an effect of localizing the magnetic moment Mn, high K_{AF} is obtained. In the same manner, high K_{F} is demanded for the write/read layer (upper layer F film 400). This is because the effective (KV)/(k_{B}T) value of the write/read layer: (K_{F}V_{F})_{eff.}/(k_{B}T) value cannot be increased (within a temperature range of RT to T_{B}) in a case where the write/read layer has no high K_{F} even when the (K_{AF}V_{AF})/(k_{B}T) product of the antiferromagnet having high K_{AF} is superimposed on the (K_{F}V_{F})/(k_{B}T) product of the write/read layer.

Further, for obtaining large dH_{C}/dT and d(K_{F}V_{F})_{eff./}dT near the T_{B} value, it is necessary that the difference between the T_{B} value and the T_{N} value is large. That is, it is necessary that the lower layer AF films 300 and 301 are constituted with an AF film having a property of: “T_{B}<<T_{N}”. While the reason is not apparent, it may be said without exaggeration that only the L1₀PtMn series film constitutes the AF film having the property of: “T_{B}<<T_{N}” and having a large difference between the T_{B} value and the T_{N} value.

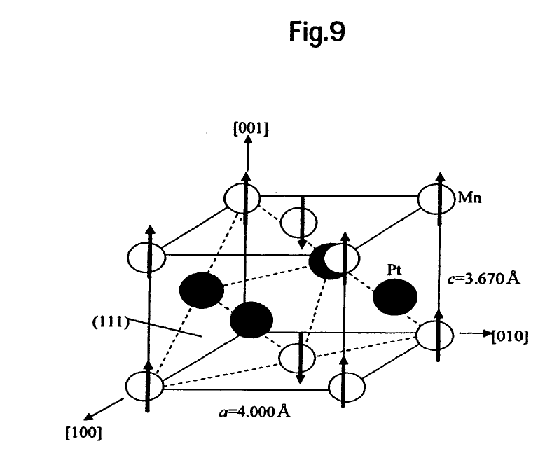

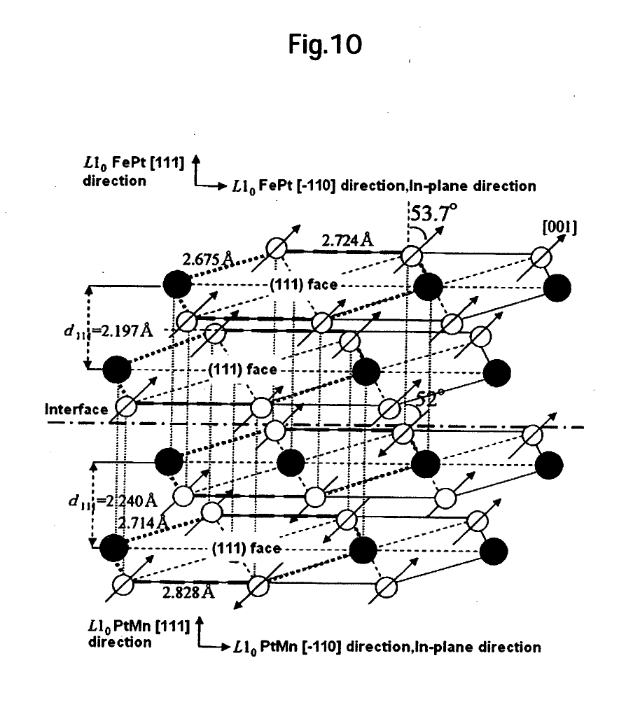

In addition, it is demanded for the lower layer AF film 300 that the anisotropy axis is substantially in an identical direction with the upper layer F film 400 and the lattice constant is about identical. FIG. 8 expresses the crystal lattice—magnetic structure of L1₀FePt, FIG. 9 expresses the crystal lattice magnetic structure of L1₀PtMn, and FIG. 10 expresses the crystal lattice magnetic structure in the (111) plane of L1₀PtMn/L1₀FePt. It can be confirmed that:

the lattice constant (a, c) of L1₀PtMn is relatively identical with the lattice constant of L1₀FePt,

L1₀PtMn(111) face spacing (d₁₁₁) is relatively identical with the L1₀FePt(111) face spacing,

the length for each side of the L1₀PtMn(111) hexagonal close packing lattice is relatively identical with the length for each side of the L1₀FePt(111) hexagonal close packing lattice, and

the direction of the anisotropy axis of L1₀PtMn is substantially identical with the direction of the anisotropy axis of L1₀FePt. As described above, it can be elucidated that the L1₀PtMn series film has the lattice constant and the lattice parameter nearly identical and the anisotropic axis in substantially identical direction with those of the upper layer F film 400. Further, since the lattice constant and the lattice parameter are similar and the anisotropic axis is substantially in the identical direction, it can be said that scattering of magnetic exchange coupling and scattering of the anisotropy axis between grains can be suppressed as much as possible in the L1₀PtMn series/L1₀FePt series [111] axis oriented magnetic exchange coupling bi-layered medium. That is, it can be said that a magnetic exchange coupling bi-layered medium having identical magnetic exchange coupling and anisotropic axis in the identical direction for any of the magnetization reversal units can be provided.

Finally, while the description has been made for the magnetic exchange coupling bi-layered medium to a case of the tilted magnetic anisotropy magnetic recording, it can be applied also for the in-plane magnetic recording and the perpendicular magnetic recording.

Further, since heat-assisted magnetic recording is conducted by utilizing the property of T_{B} and “T_{B}<<T_{N}” and since T_{B} is in a relation: T_{B}<T_{C}<T_{N}, it also provides an effect free from recording loss due to thermal fluctuation of the AF spins. That is, in a case of conducting heat-assisted magnetic recording by utilizing T_{N} (<T_{C}) described in patent document 1, T_{B}≈T_{N} (<T_{C}) described in patent document 2, or T_{cE}≈T_{N} (<T_{C}) described in patent document 3, since K_{AF} just below T_{N} is small, a (K_{AF}V_{AF}) product just below T_{N} is small. Accordingly, since “AF/F” magnetic exchange coupling due to cooling and freezing T_{N} or T_{B}≈T_{N} or T_{cE}≈T_{N} or lower may possibly occur in a state where the thermal fluctuation of the AF spins is large as it is, it may possibly cause a case where heat-assisted magnetic recording cannot be conducted in the direction of the recording magnetic field. However, in a case of conducting heat-assisted magnetic recording by utilizing the property of T_{B} and “T_{B}<<T_{N}”, and in a case where T_{B} is in a relation: T_{B}<T_{C}<T_{N}, since the K_{AF} value is large and, accordingly, the (K_{AF}V_{AF}) product is large at the temperature T_{B}, it also provides an effect capable of avoiding such recording loss.

Further, in a case where the upper layer film is an L1₀FePt series film, since the ordering temperature of the L1₀PtMn series film is as low as 230 to 275° C., it also provides an auxiliary effect that the dynamic stress formed upon ordering of the L1₀PtMn series film lowers the ordering temperature of the L1₀FePt series film.

### EXAMPLE 2

For preventing degradation of the medium by heat irradiation applied over and over, it is necessary to lower T_{W}. It is desired that T_{B} is set to about 275° C. at the highest. For this purpose, it is necessary to lower T_{B} of the lower layer AF film 300 to about 230° C. Further, for further improving easy writing at a high temperature, it is necessary to lower T_{C} of the upper layer F film 400 to about 350° C. and decrease H_{C} at T=T_{W}.

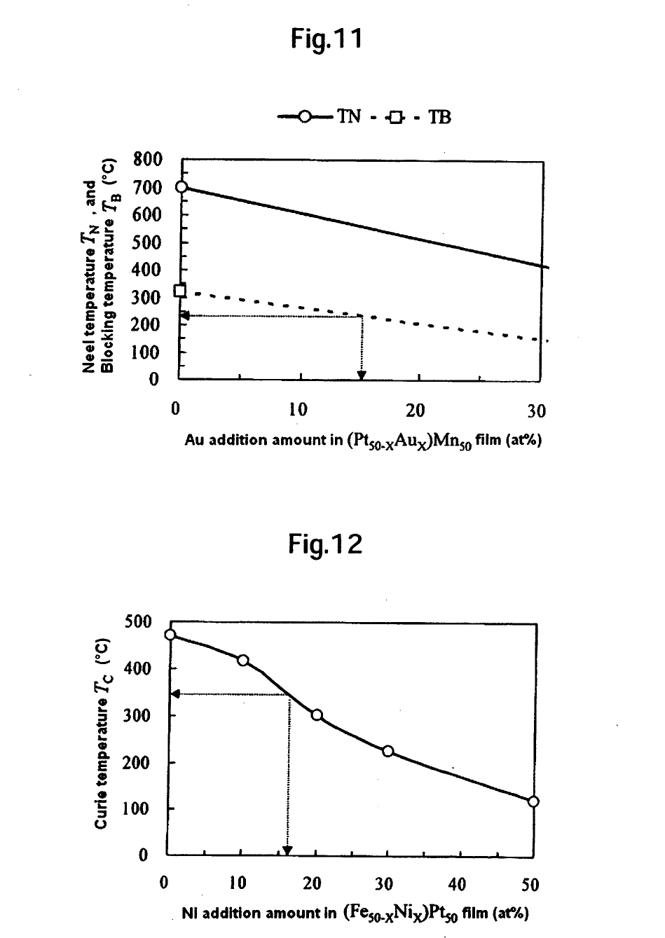

FIG. 11 shows a relation of T_{B} and T_{N} to Au addition amount in the L1₀(Pt_{50-X}Auₓ)Mn₅₀ (in atomic %) film. It can confirmed that T_{B} and T_{N} in the L1₀(Pt_{50-X}Auₓ)Mn₅₀ is lowered as the Au addition amount increases. It has been found that T_{B}=230° C. can be obtained at the Au addition amount of about 15 atomic %. Also in the L1₀(Pt_{50-X}Auₓ)Mn₅₀ film, the property: T_{B}<<T_{N} is present.

FIG. 12 shows a relation of T_{C} to Ni addition amount in the L1₀(Fe_{50-X}Niₓ)Pt₅₀ (in atomic %) film. It has been found that T_{C} of the L1₀(Fe_{50-X}Niₓ)Pt₅₀ film is lowered as the Ni addition amount increases. It has been found that T_{C}=350° C. can be obtained at the Ni addition amount of about 16 atomic %.

As described above, since the material capable of lowering T_{B} of the lower layer AF film 300 to about 230°: L1₀Pt₃₅Mn₅₀—Au₁₅ and a material capable of lowering T_{C} of the upper layer F film 400 to about 350° C.: L1₀Fe₃₄Pt₅₀—Ni₁₆ can be obtained, the magnetic exchange coupling bi-layered medium (one example) for use in best heat-assisted magnetic recording medium according to an embodiment of the invention is to be described.

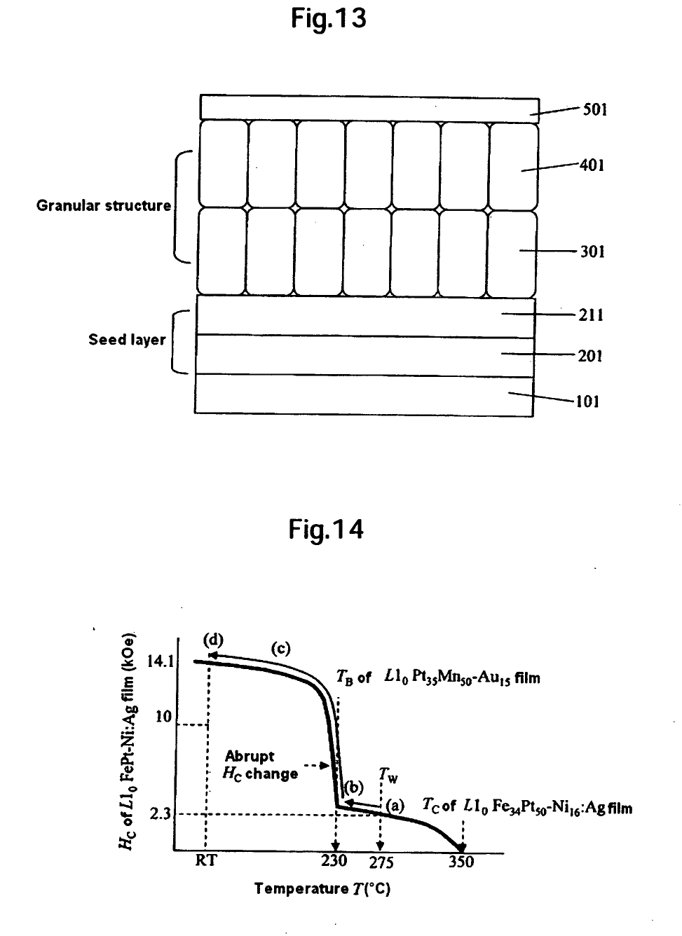

FIG. 13 shows a magnetic exchange coupling bi-layered medium for use in heat-assisted magnetic recording according to an embodiment of the invention. The medium has, on a substrate 101, layers formed by successively stacking an underlayer film 201, a heat sink layer 211, an L1₀PtMn—Au film 301 comprising an antiferromagnet (AF) at high K_{AF} of T_{B}<T_{W}, an L1₀FePt—Ni: Ag film 401 comprising a ferromagnet (F) as a write/read layer at high K_{F} of T_{N}<T_{C}, and a protective film 501. The L1₀PtMn—Au film 301 is constituted so as to satisfy relations: T_{B}<<T_{N}, T_{B}<T_{C}<T_{N}. T_{W}: recording temperature, T_{C}: Curie temperature, T_{N}: Neel temperature, T_{B}: blocking temperature, K_{F}: crystal magnetic anisotropy energy constant of ferromagnet, and K_{AF}: crystal magnetic anisotropy energy constant of antiferromagnet. Further, since Ag in the L1₀FePt—Ni: Ag film 401 is not solid solubilizable with L1₀FePt—Ni and, accordingly, precipitates at the grain boundary (not intruding in the grain), it is expressed with addition of mark “:” as L1₀FePt—Ni: Ag.

The substrate 101 comprises, for example, a glass substrate, the underlayer film 201 comprises, for example, a Ta film, the heat sink layer 211 has, for example, an fcc structure and comprising a Cu film of excellent heat conductivity (specific resistivity ρ≦25 μΩcm), the under layer AF film 301 comprises, for example, an L1₀Pt₃₅Mn₅₀—Au₁₅ film, the upper layer F film 401 comprises, for example, an L1₀Fe₃₄Pt₅₀—Ni₁₆:Ag film, and the protective film 501 comprises, for example, a C film. The Ta seed layer/Cu heat sink layer also serves as a seed layer for the L1₀PtMn—Au/L1₀FePt—Ni:Ag layer thereabove. In a case of low temperature formation, crystal orientation of amorphous Ta/Cu (111)/L1₀Pt₃₅Mn₅₀—Au₁₅ (111)/L1₀Fe₃₄Pt₅₀—Ni₁₆:Ag (111) as dense surface for each layer is obtained to form a (111) orientated film. A typical film thickness is 5 nm for the underlayer film 201, 30 nm for the heat sink layer 211, 12.5 nm for the lower layer AF film 301, 2.5 nm for the upper layer F film 401, and 3 nm for the protective film 501. Further, the L1₀PtMn—Au (111)/L1₀FePt:Ag (111) film on the Ta/Cu (111) seed layer has a granular structure and the typical grain size is 10 nm. Since T_{B} of the L1₀Pt₃₅Mn₅₀Au₁₅ film is about 230° C., T_{C} of the L1₀Fe₃₄Pt₅₀—Ni₁₆:Ag film is about 350° C., and T_{N} of the L1₀Pt₃₅Mn₅₀—Au₁₅ film is about 550° C. (FIG. 11), the L1₀Pt₃₅Mn₅₀—Au₁₅ film satisfies the relations: T_{B}<<T_{N}, and T_{B}<T_{C}<T_{N} described above.

The intrusion depth of a laser light or near-field light used in the heat assisted magnetic recording to the inside of the film is about 30 nm. Further, in order that the L1₀PtMn—Au film shows antiferromagnetism, a film thickness of about 12 nm or more is necessary. Further, the protective film of about 3 nm is necessary for the uppermost layer as described above. From the foregoing, since the maximum film thickness of the L1₀FePt—Ni:Ag film has to satisfy a relation (intrusion depth of laser light/near-field light to the inside of 30 nm-protective film of 3 nm-necessary minimum film thickness of L1₀PtMn—Au of 12 nm), it is about 15 nm. On the other hand, in a case where the thickness of the L1₀FePt—Ni:Ag film is excessively thin, it cannot be ferromagnet and becomes superparamagnet. Considering the above, the thickness of the L1₀FePt—Ni:Ag film has to be within a range of about 1.7 to 15 nm. Since the L1₀PtMn—Au film thickness on one side has to satisfy a relation: (intrusion depth of laser light/near-field light to the inside of 30 nm-protective film of 3 nm-L1₀FePt—Ni:Ag film of 1.7 to 15 nm thickness), it should be constituted within a range of about 12 to 25.3 nm.

When the K_{F} value of the L1₀Fe₃₄Pt₅₀—Ni₁₆:Ag film and the K_{AF} value of the L1₀Pt₃₅Mn₅₀—Au₁₅ film necessary for the calculation of the (K_{F}V_{F})_{eff.}/(k_{B}T) value are set to 7.5×10⁶ erg/cm³ and 2.0×10⁶ erg/cm³, respectively, while considering the factor for the dirtiness inherent to the material (such as lattice defects or inclusion of impurities due to low temperature formation), the (K_{F}V_{F})_{eff.}/(k_{B}T) value at RT of the upper layer F film 401, the (K_{F}V_{F})/(k_{B}T) value at RT of the L1₀Fe₃₄Pt₅₀—Ni₁₆:Ag single layered film, and the (K_{AF}/V_{AF})/(k_{B}T) value at RT of the L1₀Pt₃₅Mn₅₀—Au₁₅ film can be calculated and the thermal fluctuation resistance as described below can be discussed.

In a case where the lower layer AF film 301 comprises an L1₀Pt₃₅Mn₅₀—Au₁₅ film of 12.5 nm thickness, the upper layer F film 401 comprises an L1₀Fe₃₄Pt₅₀—Ni₁₆:Ag film of 2.5 nm thickness, and the grain size of L1₀Pt₃₅Mn₅₀—Au₁₅/L1₀Fe₃₄Pt₅₀—Ni₁₆:Ag is 10 nm, the (K_{F}V_{F})_{eff}/(k_{B}T) value at RT of the upper layer F film 401 showed an extremely large value of about 84 by “AF/F” magnetic exchange coupling of 2 layers of “lower layer AF film 301/upper layer F film 401”. Since the (K_{F}V_{F})/(k_{B}T) value at RT of the L1₀Fe₃₄Pt₅₀—Ni₁₆:Ag single layered film was about 36, it can be seen that it could be increased to an extremely large value by superposition of the large (K_{AF}V_{AF})/(k_{B}T) value of about 48 of the L1₀Pt₃₅Mn₅₀—Au₁₅ film (RT) by “AF/F” magnetic exchange coupling. Further, the large (K_{F}V_{F})/(k_{B}T) value is maintained within a temperature range of: RT to T_{B}.

FIG. 14 shows an H_{C} to temperature relation of the upper layer F film 401 in the magnetic exchange coupling bi-layered medium for use in heat-assisted magnetic recording according to an embodiment of the invention. The H_{C} value at RT of the upper F film 401 showed a large value of about 14.1 kOe by “AF/F” magnetic exchange coupling of the two layers of “under layer AF film 301/upper layer F film 401”. Since the H_{C} value at RT of the L1₀Fe₃₄Pt₅₀—Ni₁₆:Ag single layer film was about 6 kOe, it has been found that it is increased to a large value by the “AF/F” magnetic exchange coupling and can exceed the maximum magnetic field of 10 kOe of the recording head. Further, the large H_{C} value at RT of the upper layer F film 401 gradually decreased in the manner of Brillouin function along with temperature increase, decreased abruptly at about 230° C. as the T_{B} value of the lower layer AF film 301 (L1₀Pt₃₅Mn₅₀—Au₁₅ film) and just below: T_{W}≈275° C. (that is, temperature at which “AF/F” magnetic exchange coupling disappears) and then showed the H_{C} value in accordance with the temperature dependence of H_{C} of the upper layer F single layered film. As shown in FIG. 14, the change of the H_{C} value to the temperature (that is, dH_{C}/dT) is extremely abrupt (stepwise or stair-like) near the T_{B} value and just below the T_{W} value. Further, the H_{C} value of the upper layer F film 401 near: T_{W}≈275° C. was about 2.3 kOe. Since the maximum recording magnetic field of a current head is as high as about 10 kOe, writing (recording) is easy to the upper layer F film 401 in which the H_{C} value is lowered as far as about 2.3 kOe near T_{W}≈275° C. Further, in FIG. 14, the hysteresis of H_{C} during heat-assisted recording is (a)→(b)→(c)→(d) shown in the drawing.

Further, while description has been made as: T_{W}≈275° C., it is desirable that T_{W}, is preferably about 200° C. while considering the heat irradiation applied over and over.

As described above, it has been found that an extremely high heat fluctuation resistance and high H_{C} value can be obtained within a temperature range of RT to T_{B} by “AF/F” magnetic exchange coupling of the two layers of “lower layer AF film 301/upper layer F film 401”. Further, it has been found that the contradiction to easy writing at a high temperature (T_{W}) can be overcome. Further, it has been found that the change of the H_{C} value to the temperature near the T_{B} value and just below T_{W} can be made abrupt. That is, it has been found that a large dH_{C}/dT can be obtained.

In the same manner as in Example 1, the problems can be solved for the temperature lowering of the film deposition process of the L1₀FePt—Ni:Ag film by an Ar discharge cleaning and sputtering film deposition at high Ar pressure, for the orientation of L1₀FePt—Ni:Ag film in the specific anisotropy axis ([111]axis orientation) by the arrangement of a Ta/Cu (111) seed layer, and for the granulation of the L1₀FePt—Ni:Ag film by the self-assembled method by sputtering film deposition at high Ar pressure and the addition of elements not solid solubilizable with L1₀FePt—Ni: Sn, Pb, Sb and Bi.

Accordingly, by using the “AF/F” magnetic exchange coupling bi-layered medium of two layers of “lower layer AF film 301/upper layer F film 401” shown in Example 2, it is possible to obtain a heat-assisted magnetic recording medium capable of simultaneously satisfying three conditions:

(1) capable of overcoming contradiction between the thermal fluctuation resistance at RT and easy writing at high temperature (T_{W}),

(2) capable of making the H_{C} to temperature change abrupt just below T_{W}, and

(3) (a) low temperature formation, (b) specific anisotropy axis orientation ([111] axis orientation), and (c) granulation.

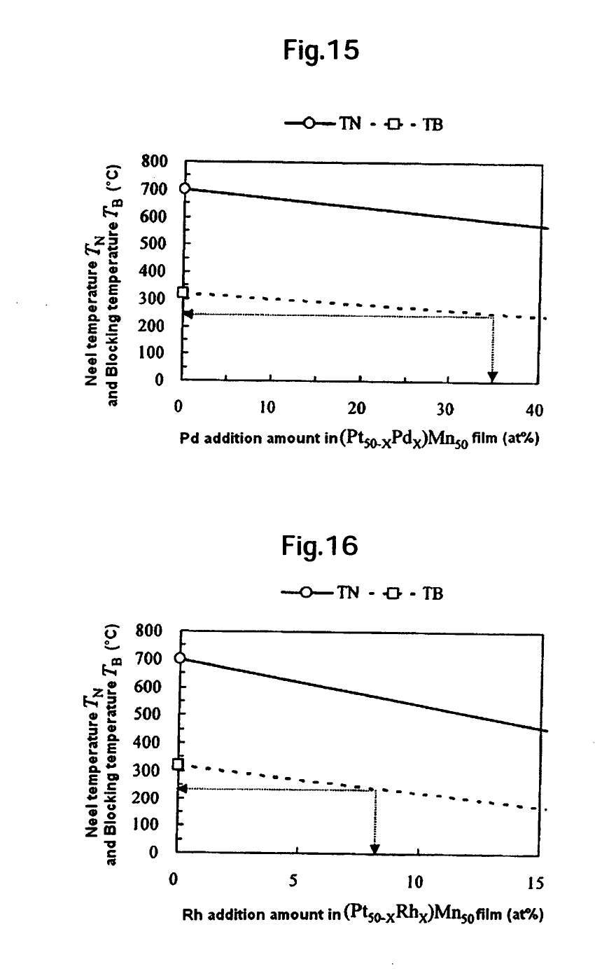

FIG. 15 shows a relation of T_{B} and T_{N} to the Pd addition amount in the L1₀(Pt_{50-X}Pd_{X})Mn₅₀ (in atomic %) film according to an embodiment of the invention. It can be confirmed that T_{B} and T_{N} are lowered as the Pd addition amount increases in the L1₀(Pt_{50-X}Pd_{X})Mn₅₀ film. It has been found that T_{B}≈230° C. is obtained at the Pd addition amount of about 35 atomic %. Also in the L1₀(Pt_{50-X}Pd_{X})Mn₅₀ film, there is present a property “T_{B}<<T_{N}”. In addition, it is to be emphasized that a relation: T_{B} (about 230° C.)<T_{C} (about 350° C.)<T_{N} (about 600° C. in FIG. 15) is satisfied in a case of selecting the L1₀Fe₃₄Pt₅₀—Ni₁₆:Ag film as the upper layer F film 401.

In the same manner, FIG. 16 shows a relation of T_{B} and T_{N} to the Rh addition amount in the L1₀(Pt_{50-X}Pd_{X})Mn₅₀ (in atomic % film). It can be confirmed that T_{B} and T_{W} are lowered as the Rh addition amount is increased in the L1₀(Pt_{50-X}Rh_{X})Mn₅₀ film. It has been found that T_{B}≈230° C. is obtained at the Rh addition amount of about 8 atomic %. Also in the L1₀(Pt_{50-X}Rh_{X})Mn₅₀ film, a property “T_{B}<<T_{N}” is present. In addition, it is to be emphasized that a relation T_{B}(about 230° C.)<T_{C} (about 350° C.)<T_{N} (about 550° C., FIG. 16)] is satisfied in a case of selecting the L1₀Fe₃₄Pt₅₀—Ni₁₆:Ag film as the upper layer F film 401.

From the foregoing, it is possible to use the L1₀PtMn—Pd film and the L1₀PtMn—Rh film instead of the L1₀PtMn film and the L1₀PtMn—Au film as the lower layer AF films 300, 301.

Finally, since the reason why H_{C} increases abruptly (stepwise) at a temperature: T=T_{B} in the heat-assisted magnetic recording process of a magnetic exchange coupling bi-layered medium for use in heat-assisted magnetic recording medium according to Example 2, the direction of the magnetization vector after recording (tilted magnetic anisotropy recording), etc. are substantially identical with that in Example 1, description therefor is omitted.

Further, while magnetic recording is conducted with the tilted magnetic anisotropy for the magnetic exchange coupling bi-layered medium, it can be applied also to the in-plane magnetic recording and the perpendicular magnetic recording.

Then, a case where a temperature relation for T_{W} and T_{C} of the upper layer F films 400, and 401 and a temperature relation for T_{B} and T_{W} of the lower layer AF films 300 and 301 are reversed is to be summarized below:

In a case where the temperature relation for T_{W} and T_{C} of the upper layer F films 400, 401 is T_{W}>T_{C}, and since this is recording in the paramagnetic state, writing cannot be conducted.

In a case where the temperature relation for T_{B} and T_{W} of the lower layer AF films 300, 301 is T_{B}>T_{W}, and since large magnetic exchange coupling is formed, recording is conducted to the upper layer F films 400, 401 and writing cannot be conducted.

That is, in a case even only one of the temperature relations is reversed, the heat-assisted magnetic recording medium described in Examples 1 and 2 capable of making the H_{C} to temperature change abrupt just below T_{W} cannot be obtained.

Further, the reason why it is necessary to satisfy the relation not only for “T_{B}<<T_{N}” but also for “T_{B}<T_{C}<T_{N}” in the lower layer AF films 300, 301 is as described below.

In order to conduct good and stable heat-assisted magnetic recording, it was necessary to ensure a temperature region in which the H_{C} to temperature change was relatively moderated, in the “H_{C} to temperature” characteristics of the upper layer F films 400, 401 at T_{B} or higher and ensure a temperature region in a low H_{C} state and it was desirable that T_{B} was set lower by about 100 to 150° C. than T_{C} for satisfying the conditions: T_{B}≈T_{C}−[100-150° C.] [it is judged that the difference between the T_{B} value and the T_{C} value is desirably about from 100 to 150° C. described above since H_{C} at T=T_{W} becomes large possibly making it difficult for recording in a case of increasing the difference between the T_{B} value and the T_{C} value thereby excessively widening the temperature region where the H_{C} to temperature change becomes relatively moderate and, on the other hand, in a case where the difference between the T_{B} value and the T_{C} value is made excessively small intended for recording to the low H_{C} state, T_{W} may possibly exceed T_{C} making it difficult for the recording].

For increasing <S_{AF}> and 2J_{AF}<S_{AF}><S_{AF}> in the lower layer AF films 300, 301 at a temperature T_{B} in order to obtain large dH_{C}/dT and d(K_{F}V_{F})_{eff.}/dT, it is necessary to make the difference between the T_{N} value and the T_{B} value as large as possible and it is necessary that T_{N} is higher by about 200 to 250° C. than T_{B}:T_{N}≈T_{B}+[200 to 250° C. (and or above)]=T_{C}−[100 to 150° C.]+[200-250° C. (and or above)]=T_{C}+[50 to 150° C. (and or above)], so that it is necessary for the relation: T_{B}≈T_{C}−[100 to 150° C.]<T_{C}<T_{N}≈T_{C}+[50 to 150° C. (and or above)] and, accordingly, the relation: “T_{B}<T_{C}<T_{N}” has to be satisfied.

Further, in a case of T_{N}<T_{C}, if T_{W} should increase to the vicinity of T_{C}, since the temperature in the lower layer AF layers 300, 301 exceeds T_{N}, the AF state disappears briefly to form a Para.state. Then, when the Para.state resumes the AF state again in the cooling process, since K_{AF} just below T_{N} is small, it may possibly result in a case where it is cooled (field cooled) and frozen to T_{B} or lower in a state where the (K_{AF}V_{AF}) product just below T_{N} is small as it is, that is, in a state where thermal fluctuation of AF spins is large to sometimes cause “AF/F” magnetic exchange coupling, so that heat-assisted magnetic recording cannot sometimes be conducted in the direction of the recording magnetic field. T_{C}<T_{N} has to be satisfied also in view of the above, and since it is also necessary to satisfy T_{B}<T_{W}, T_{W}<T_{C} (that is, T_{B}<T_{C}) as described above, the relation: “T_{B}<T_{C}<T_{N}” has to be satisfied.

The reason why the heat-assisted magnetic recording cannot be conducted in the direction of the recording magnetic field described above is to be described specifically as below. According to Neel's study, the relaxation time T of a magnet is described as: τ=τ₀exp(KV/k_{B}T) (τ₀=10⁻⁹ s). At about or just below T_{N}, it is at the order of 10⁻⁹ s assuming K_{AF}≈0 (that is, AF spins cause vertical movement and thermal fluctuation at the order of 10⁻⁹ s), and it is about identical with the order of the cooling time of 10⁻⁹ s to T_{B} in the thermal magnetic recording cooling process. Accordingly, the followings may possibly occur.

(a) “AF/F” magnetic exchange coupling grains that satisfy (time till the AF spin arrangement in the lower layer AF films 300, 301 directed to the random direction by thermal fluctuation near T_{N} causes convergence of the AF spin arrangement in a certain direction of the anisotropy axis [001] or [00-1] direction)<(cooling time necessary for temperature lowering from the vicinity of T_{N} to T_{B}) conduct magnetic exchange coupling in the direction in accordance with the direction of the recording magnetic field, and

(b) some “AF/F” magnetic coupling grains satisfy: (time till the AF spin arrangement in the lower layer AF films 300, 301 directed to the random direction by thermal fluctuation near T_{N} causes convergence of the AF spin arrangement in a certain direction of the anisotropy axis [001] or [00-1] direction)>(cooling time necessary for temperature lowering from the vicinity of T_{N} to T_{B}).

In a case of (b), since the “AF/F” magnetic exchange coupling is formed with AF spins in the lower layer AF films 300, 301 being directed as such to the random direction, the direction of the spins in the upper layer F films 400, 401 is directed to the direction reflecting the direction of the random AF spins in the lower layer AF films 300, 301 to conduct thermal magnetic recording. That is, also the spins in the upper layer F films 400, 401 are directed to the random direction and put to thermal magnetic recording. This is the reason why the thermal magnetic recording cannot sometimes be conducted in the direction of the recording magnetic field in a case of T_{N}<T_{C}. While description has been made to a case where T_{W} exceeds T_{N}, this is a phenomenon which may possibly occur also in a case where T_{W} increases to the vicinity of T_{N} even when T_{W} does not exceed T_{N}.

Further, in Examples 1 and 2, the heat sink layers 210, 211 are not restricted to Cu. The heat sink layers 210, 211 may also be constituted with an Au film, Ag film, Pt film, Pd film, Rh film, AuCu film, PtAu film, AuAg film, an alloy film formed by combining such elements, Au₃Cu ordered phase film, L1₀AuCu film, or AuCu₃ ordered phase film having the fcc structure and excellent heat conductivity. In a case of using the Au₃Cu ordered phase film, L1₀AuCu film or the AuCu₃ ordered phase film, since the ordering temperature of the Au₃Cu ordered phase film (bulk ordering temperature: 200° C.), L1₀AuCu film (bulk ordering temperature: 408° C.), AuCu₃ ordered phase film (bulk ordering temperature: 390° C.) is extremely low, they also provide an auxiliary effect that the dynamitic stress caused upon ordering of Au₃Cu, AuCu, AuCu₃ lowers the ordering temperature of the L1₀FePt series film.

Further, in Examples 1 and 2, the lower layer films 200, 201 disposed below the heat sink layers 210, 211 are not restricted to the Ta film. Any film capable of obtaining only (111) orientation of the fcc metal film described above constituting the heat sink layers 210, 211 may be used. For example, they may be a Zr film, Hf film or FeNiCr film. Further, they may be comprised with a stacked film such as a Ta/Cu/Ru stacked film, an Hf/Cu/Ru stacked film, and an FeNiCr/Cu/Ru stacked film. While the Ru film has an hcp structure, it shows Ru (001) orientation on Ta/Cu, Hf/Cu, FeNiCr/Cu. Since within the Ru (001) plane and within the fcc (111) face of the heat sink layer described above have an identical closed pack hexagonal lattice, the fcc (111) face of the heat sink layer grows epitaxially on the Ru (001) face to obtain orientation only fcc (111).

Further, in Examples 1 and 2, the upper layer F films 400, 401 as the write/read layer of high K_{F} are not restricted to the L1₀FePt series film. The upper layer F films 400, 401 may be constituted also with a Co-based alloy film whose composition is controlled so as to satisfy a relation: “T_{B}<T_{C}<T_{N}”. Specifically, they includes Co-based alloy films such as an SmCo alloy film, CoCr alloy film, CoPt alloy film, CoCrTa alloy film, CoCrPt alloy film, CoCrTaPt alloy film, Co₃Pt alloy film, CoCrPt—SiO₂ alloy film.

Further, the upper layer F films 400, 401 may also be constituted with [Co/Pt]ₙ multilayer film or [Co/Pd]ₙ multilayer film controlled for the film thickness for each layer so as to satisfy the relation: “T_{B}<T_{C}<T_{N}”.

Further, the upper layer F films 400, 401 may also be constituted with an amorphous rare earth metal (RE)-transition metal (TM) alloy film whose composition is controlled so as to satisfy the relation: “T_{B}<T_{C}<T_{N}” such as a TbFe alloy film, TbFeCo alloy film, TbCo alloy film, GdTbFeCo alloy film, GdDyFeCo alloy film, NdFeCo alloy film, or NdTbFeCo alloy film.

However, since the materials described above have smaller K_{F} values compared with the L1₀FePt series film, the thermal fluctuation resistance at RT: the (K_{F}V_{F})_{eff.}/(k_{B}T) value is inevitably smaller when compared with the L1₀FePt series film. Further, as will be described below, in a case of using an L1₀PtMn series (111) oriented film for the lower layer F films 300, 301, and a Co-based alloy film, a [Co/Pt]ₙ multilayer film, [Co/Pd]ₙ multilayer film, and the amorphous RE-TM alloy film for the upper layer F films 400, 401, while provides a magnetic exchange coupling bi-layered medium corresponding to the perpendicular magnetic recording, this may result in a problem of causing the disturbance of the anisotropic axis in the write/read layer.

The Co-based alloy film conducts hcp (001) orientation on the L1₀PtMn series (111) face and the [Co/Pt]ₙ multilayer film and the [Co/Pd], multilayer film conduct (111) orientation on the L1₀PtMn series (111) face. Accordingly, in a case where the Co-based (001) oriented alloy film, the [Co/Pt]ₙ(111) oriented multilayer film, and the [Co/Pd]ₙ(111) oriented multilayer film are formed on the L1₀PtMn series (111) oriented film, since the anisotropic axes of the Co-based (001) oriented alloy film, the [Co/Pt]ₙ(111) oriented multilayer film, and the [Co/Pd]ₙ(111) oriented multilayer film are in the direction perpendicular to the plane, that is, in the perpendicular magnetization direction, they form magnetic exchange coupling bi-media corresponding to the perpendicular magnetic recording. However, the anisotropy axis of the L1₀PtMn series (111) oriented film is in the direction tilted by about 52° from the direction perpendicular to the plane (refer to FIG. 10). Accordingly, misalignment of the anisotropy axis is caused between anisotropy axes of the Co-based (001) oriented alloy film, the [Co/Pt]ₙ(111) oriented multilayer film, and the [Co/Pd]ₙ(111) oriented multilayer film (direction perpendicular to the plane) and the anisotropy axes of the L1₀PtMn series (111) oriented film (direction tilted by about 52° from the direction perpendicular to the plane) and disturbance for the anisotropy axes may possibly be caused to the Co-based (111) oriented alloy film, the [Co/Pt]ₙ (111) oriented multilayer film, and the [Co/Pd]ₙ (111) oriented multilayer film supporting the write/head layer by the “AF/F” magnetic exchange coupling. That is, the anisotropy axes of the Co-based (001) oriented alloy film, the [Co/Pt]ₙ (111) oriented multilayer film, and the [Co/Pd]ₙ(111) oriented multilayer film are somewhat disturbed from the direction perpendicular to the plane. Accordingly, in a case of using such materials as the write/read layer, it is necessary for such consideration as making the (K_{F}V_{F}) product of the Co-based alloy film, the [Co/Pt]ₙ multilayer film, and the [Co/Pd]ₙ multilayer film larger than the (K_{AF}V_{AF}) product of the L1₀PtMn series film in order to minimize the disturbance of the anisotropy axes from the direction perpendicular to the plane.

Further, the RE-TM alloy film described above becomes amorphous irrespective of the lower layer and the direction of the anisotropy axis is in the direction perpendicular to the plane, that is, in the direction of perpendicular magnetization. Accordingly, also in a case of forming the RE-TM alloy film on the L1₀PtMn series (111) oriented film, since the anisotropy axis of the RE-TM alloy film is in a direction perpendicular to the plane, that is, in the direction of perpendicular magnetization, it forms a magnetic exchange coupling bi-layered medium corresponding to perpendicular magnetic recording. However, the direction of the anisotropy axis of the L1₀PtMn series (111) oriented film is in a direction tilted by about 52° from the direction perpendicular to the plane as described above. Accordingly, also in a case of using the RE-TM alloy film, a problem of misalignment of the anisotropy axes is resulted, and disturbance for the anisotropy axes may possibly be caused to the RE-TM alloy film supporting the write/read layer by the “AF/F” magnetic exchange coupling. Also in this case, it is necessary for consideration such as making the (K_{F}V_{F}) product of the RE-TM alloy film larger than the (K_{AF}V_{AF}) product of the L1₀PtMn series film so as to minimize the disturbance of the anisotropy of the axis from the direction perpendicular to the plane.

In a case of selecting the RE-TM alloy film as the upper layer F films 400, 401, it is possible to render the crystal orientation property of the L1₀PtMn series film constituting the lower layer AF films 300, 301 into (002) orientation thereby changing the direction of the anisotropy axis to the perpendicular direction, that is, to the direction perpendicular magnetization direction, to align the direction of the anisotropy axis of the RE-TM alloy film (direction perpendicular to the plane, that is, the perpendicular magnetization direction) with the direction of the anisotropy axis of the L1₀PtMn series film. In this case, since it is necessary to render the L1₀PtMn series film into (002) orientation, the lower layer films 200, 201/heat sink layers 210, 211 have to be constituted, only in this case, by the combination of any one of the following cases. They should be constituted with Fe(002)/Pt(002) film, Cr(002)/Pt(002) film, CrRu(002)/Pt(002) film, RuAl(002)/Pt(002) film, Fe(002)/Au(002) film, Cr(002)/Au(002) film, CrRu(002)/Au(002) film, RuAl/(002)Au(002) film, Fe(002)/Ag(002) film, Cr(002)/Ag(002) film, CrRu(002)/Ag(002) film, RuAl(002)/Ag(002) film, MgO(002)/Pt(002) film, MgO(002)/Au(002) film, MgO(002)/Ag(002) film, [MgO(002)/Fe(002)]/Pt(002) film, [MgO(002)/Cr(002)]/Pt(002) film, [MgO(002)/CrRu(002)]/Pt(002) film, [MgO(002)/Fe(002)]/Au(002) film, [MgO(002)/Cr(002)]/Au(002) film, [MgO(002)/CrRu(002)]/Au(002) film, [MgO(002)/Fe(002)]/Ag(002) film, [MgO(002)/Cr(002)]Ag(002) film, or [MgO(002)/CrRu(002)]/Ag(002) film.

The lower layer film/heat sink layer described above can function as an extremely effective seed layer also in view of putting both the L1₀PtMn series film and the L1₀FePt series film into (002) orientation, changing the direction of the anisotropy axes of both of them in the direction perpendicular to the plane, that is, in the perpendicular magnetization direction thereby obtaining an “L1₀PtMn series(AF)/L1₀FePt series(F)” magnetic exchange coupling bi-layered medium corresponding to the perpendicular magnetic recording.

Further in Examples 1 and 2, the lower layer AF films 300, 301 may also be constituted with an L1₀NiMn film, γ-FeMn film, γ-MnIr film, γ-MnRh film, γ-MnRu film, γ-MnNi film, γ-MnPt film, γ-MnPd film, γ-Mn(PtRh) film, γ-Mn(RuRh) film, or ordered phase Mn₇₅Ir₂₅ film. Further, they may also be constituted with a random phase CrMnM film. As the third element M, Pt, Rh, Pd, and Cu are preferred, and two or more kinds of members among the elements described above may be added in combination. Further, the lower layer AF films 300, 301 may also be constituted with materials of FeRh series or FeRhIr series that cause AF→F phase transfer near 100 to 200° C. when a technique capable of lowering the ordering temperature to 350° C. or lower can be established in the future. However, since the AF films described above have smaller K_{AF} value compared with the L1₀PtMn series films, the change of H_{C} at a temperature T_{B} just below T_{W} may inevitably be decreased compared with that of the L1₀PtMn series film. Further, since the difference between the T_{B} value and the T_{N} value is smaller compared with that of the L1₀PtMn series film, the change of H_{C} at a temperature T_{B} just below T_{W} is inevitably decreased compared with that of the L1₀PtMn series film also in this regard.

The upper layer F films 400, 401 may also be constituted with all L1₀FePtCo film, L1₀FePtCo:Ag film with addition of Co to FePt, L1₀FePtCo—Ni film, L1₀FePtCo—Ni:Ag film with addition of Ni to FePtCo or L1₀CoPt film, L1₀CoPt:Ag film, L1₀CoPt—Ni film, L1₀CoPt—Ni:Ag film with addition of Ni to CoPt, L1₀CoPtPd film, L1₀CoPtPd:Ag film with addition of Pd to CoPt, L1₀CoPtPd—Ni film, L1₀CoPtPd—Ni:Ag film with addition of Ni to CoPtPd. Further, it may also be constituted with an L1₀FePd film, L1₀FePd:Ag film, L1₀FePdPt film, L1₀FePcdPt:Ag film with addition of Pt to FePd, or L1₀FePdPt—Ni film or L1₀FePdPt—Ni:Ag film with addition of Ni to FePdPt.

Further, it may also be constituted with an L1₀FePt:M film, L1₀FePtCo:M film, L1₀FePtCo—Ni:M film, L1₀CoPt:M film, L1₀CoPt—Ni:M film, L1₀CoPtPd:M film, L1₀CoPtPd—Ni:M film, L1₀FePd:M film, L1₀FePdPt:M film, or L1₀FePdPt—Ni:M film. As the third element M precipitating to the grain boundary, Cu, Sn, Pb, Sb, Bi, B and C may be used in addition to Ag described above, and two or more of members among the elements described may be added in combination. Further, in a case of selecting a chemically noble element such as Ag or Cu as the third element M, deposition of a micro amount of oxygen at the grain boundary can be decreased as much as possible. Since the presence of the micro amount of oxygen hinders the lowering of the ordering temperature for the L1₀FePt series film and L1₀CoPt series film, it can be said that Ag or Cu is a preferred third element M for lowering the ordering temperature.

The protective films 500, 501 may also be constituted with a Cu film, Cr film, Ta film, Ru film, Pd film, Ag film, Pt film, or Au film. Two or more of them may be combined. Among them, in a case of selecting a chemically noble element such as Cu, Ru, Pd, Ag, Pt, or Au, deposition of the micro amount of oxygen at the surface of L1₀FePt series film and L1₀CoPt series film can be minimized as much as possible. As described above, since the presence of the micro amount of oxygen hinders lowering of the ordering temperature for the L1₀FePt series film and the L1₀CoPt series film, Cu, Ru, Pd, Ag, Pt or Au can be said to be a protective film preferred for lowering the ordering temperature. However, such chemically noble materials cause lateral diffusion of heat because of their low resistance, a consideration is necessary for reducing the thickness as much as possible. Further, the protective films 500, 501 may also be constituted with a nitride such as SiN.

Further, an SUL layer (Soft Underlayer) may also be provided below the lower layer film 200, 201. Further, a fundamental concept of “utilizing T_{B} of “lower layer AF films 300, 301 thereby making dH_{C}/dT larger at a certain temperature” according to embodiments of the invention is applicable also to MRAM (Magnetic Random Access Memory).

### EXAMPLE 3

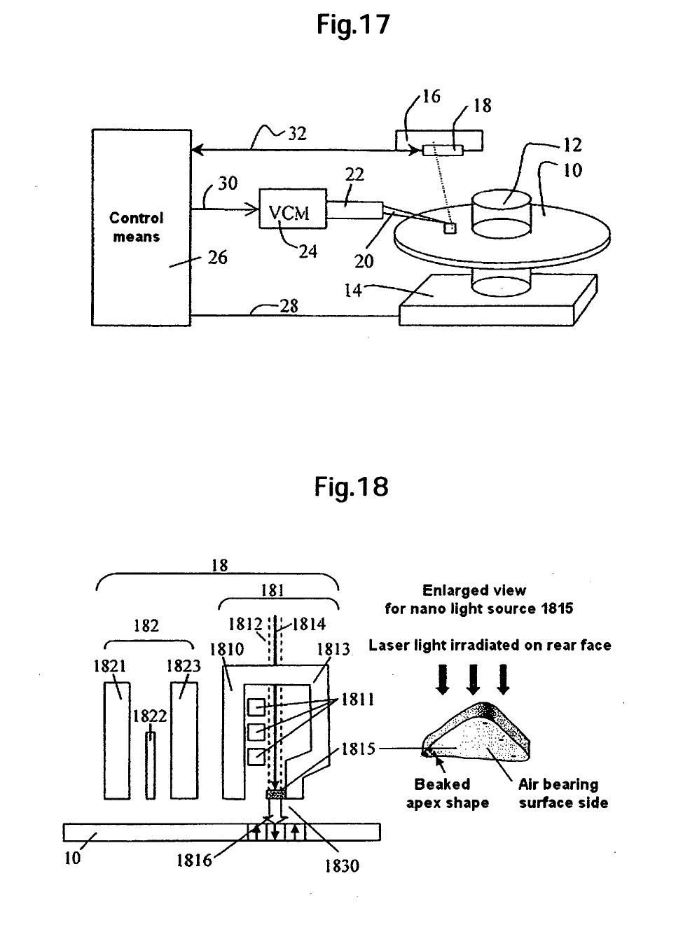

FIG. 17 is a view showing an example of a magnetic disk apparatus using the heat-assisted magnetic recording medium according to an embodiment of the invention. This shows an outline of applying the heat-assisted magnetic recording medium according to an embodiment of the invention to a magnetic disk apparatus as a magnetic recording system. However, the heat-assisted magnetic recording medium of the invention is also applicable to magnetic recording system such as a magnetic tape apparatus or optomagnetic disk apparatus.

The illustrated magnetic disk apparatus is constituted by including a magnetic disk 10 as a heat-assisted magnetic recording medium of the invention formed in a disk-shape for recording data in a coaxial recording region referred to as a track, a magnetic head 18 provided with a near-field light or laser light irradiation means for heating the heat-assisted magnetic recording medium for writing and reading the data, an actuator 24 for supporting the magnetic head 18 and moving the same to a predetermined position above the magnetic disk 10, a motor 14 for rotating the magnetic disk 10, and control means 26 for controlling sending and receiving of data read and written by the magnetic head 18, movement of the actuator means, number of rotation of the motor 14, and the temperature T_{W} upon recording on the disk 10 (in a temperature region: T_{B}<T_{W}<T_{C}<T_{N}).

Further, the constitution and the operation are to be described below. At least one magnetic disk 10 capable of rotation is supported by a rotary shaft 12 and rotated by the driving motor 14. At least one slider 16 is located above the magnetic disk 10, the slider 16 is provided by the number of one or more and supports the magnetic head 18 for reading and writing.

By the movement of the slider 16 on the desk surface at the same time with the rotation of the magnetic disk 10, it accesses a predetermined position at which an aimed data is recorded. The slider 16 is attached to an arm 22 by way of a gimbal 20. The gimbal 20 has a slight resiliency to contact the slider 16 to the magnetic disk 10 closely. The arm 22 is attached to the actuator 24. FIG. 17 also shows an enlarged schematic view of the slider 16 held on the gimbal.

The actuator 24 includes a voice coil motor. The voice coil motor comprises a movable coil placed in a fixed magnetic field, and the moving direction, moving speed, etc. of the coil are controlled by electric signals given from the control means 26 by way of a line 30. Accordingly, the actuator means according to this example comprises, for example, including the slider 16, the gimbal 20, the arm 22, the actuator 24, and the line 30.

During operation of the magnetic disk, air bearing is generated by an air flow between the slider 16 and the disk surface by the rotation of the magnetic disk 10, which floats the slider 16 from the surface of the magnetic disk 10. Accordingly, during operation of the magnetic disk apparatus, the air bearing takes a balance with a slight resiliency of the gimbal 20, and the slider 16 is kept so as to be floated not in contact with the surface of the magnetic disk and floats while keeping a predetermined space relative to the magnetic disk 10.

Usually, the control means 26 includes a logic circuit, a memory, a microprocessor, etc. The control means 26 transmits and receives control signals through each of lines and controls various constituent means of the magnetic disk apparatus. For example, the motor 14 is controlled by a motor driving signal transmitted by way of a line 28. The actuator 24 is controlled by a head position control signal and a seek control signal by way of a line 30 so as to optimally move and position the slider 16 selected to the aimed data track on the relevant magnetic disk 10. The temperature T_{W} upon recording on the disk 10 is controlled by a temperature control signal such as a laser power control signal and an irradiation time control signal by way of a line 32 such that T_{W} on the disk 10 is within a range: T_{B}<T_{W}<T_{C}<T_{N}.

Then, the control means 26 receives electric signals read and converted from the data of the magnetic disk 10 by the magnetic head 18 by way of the line 32 and decodes them. Further, it transmits electric signals for writing as data to the magnetic disk 10, and electric signals for heat-assisting to the magnetic head 18 by way of the line 32. That is, the control means 26 controls the transmission and reception of the information to be read or written by the magnetic head 18.

The reading and writing signals may be directly transmitted from the magnetic head 18. Further, the control signals include, for example, access control signals and clock signals. Further, the magnetic disk apparatus may have plural magnetic disks or actuators and the actuator may have plural magnetic heads.

Then, referring to FIG. 18, an example of the magnetic head 18 is to be described. The magnetic head 18 is constituted by including the heat-assisted magnetic recording head 181 and a reading head 182.

The heat-assisted magnetic recording head 181 is constituted by including at least a lower magnetic core 1810, coils 1811, a waveguide channel 1812 disposed, for example, between the coil 1811 and the upper magnetic core 1813 for passing a laser light 1814, and an upper magnetic core 1813. A nano light source 1815 constituted, for example, with a thin Au stripe is disposed to an air bearing surface 1830 such that a laser light 1814 is irradiated to a body part of the nano light source 1815 (on the side opposite to the air bearing surface). The top end of the nano light source 1815 has, for example, a beaked apex shape of several tens nm or less. The laser light 1814 is irradiated on the nano light source 1815 to excite plasmon in the nano light source 1815. When the plasmon is excited, a so-called near-field light 1816 (with light spot diameter of several tens of nm or less) is generated from the top end of the nano light source 1815. The heat-assisted magnetic recording medium 10 is heated locally to a desired temperature, that is, a temperature T_{W} satisfying T_{B}<T_{W}<T_{C}<T_{N} by the near-field light 1816 and the recording magnetic field from the heat-assisted magnetic recording head 181 is applied substantially simultaneously to the heat-assisted magnetic recording medium 10 thereby conducting heat-assisted magnetic recording. The reading head 182 is constituted including at least a lower shield 1821, a highly sensitive read sensor 1822 such as a GMR head or TMR head, and an upper shield 1823.

What is claimed is:

1. A heat-assisted magnetic recording medium having, on a substrate, a magnetic exchange coupling film formed by stacking a lower layer film comprising an antiferromagnet at high K_{AF} and an upper layer film comprising a ferromagnet as a write/read layer at high KF, the antiferromagnet is constituted so as to satisfy a relation: T_{B}<T_{C}<T_{N} and the coercivity H_{C} to temperature characteristic is changed stepwise with temperature T_{B} by utilizing T_{B}, assuming T_{C} as a curie temperature, T_{N} as a Neel temperature, T_{B} as a blocking temperature, K_{F} as a crystal magnetic anisotropy energy constant of the ferromagnet, and K_{AF} as crystal magnetic anisotropy energy constant of an antiferromagnet.

2. The heat-assisted magnetic recording medium according to claim 1, wherein the underlayer film comprises an L1₀PtMn system antiferromagnet, and the upper layer film comprises an L1₀FePt system ferromagnet.

3. The heat-assisted magnetic recording medium according to claim 1, wherein the underlayer film comprises an L1₀PtMn—Au system antiferromagnet, and the upper layer film comprises an L1₀FePt—Ni:Ag system ferromagnet.

4. The heat-assisted magnetic recording medium according, to claim 1, wherein the under-layer film comprises an L1₀PtMn—Pd or L1₀PtMn—Rh, and the upper layer film comprises an L1₀FePt—Ni:Ag system ferromagnet.

5. The heat-assisted magnetic recording medium according to claim 1, wherein a layer formed by successively stacking a Ta seed layer, and a Cu heat sink layer having an fcc structure is provided below the underlayer film.

6. A heat-assisted magnetic recording medium having, on a substrate, a magnetic exchange coupling film formed by stacking a lower layer film comprising an antiferromagnet at high K_{AF} of T_{B}<T_{W} and an upper layer film comprising a ferromagnet as a read/write layer at high K_{F} of T_{W}<T_{C}, the antiferromagnet is constituted so as to satisfy a relation: T_{B}<<T_{N}, and T_{B}<T_{C}<T_{N} and the coercivity H_{C} to temperature characteristic is changed stepwise with temperature T_{B} just below T_{W} by utilizing the property of T_{B} and T_{B}<<T_{N}, assuming T_{W} as a recording temperature, T_{C} as a curie temperature, T_{N} as a Neel temperature, T_{B} as a blocking temperature, K_{F} as crystal magnetic anisotropy energy constant of the ferromagnet, and K_{AF} as crystal magnetic anisotropy energy constant of an antiferromagnet.

7. The heat-assisted magnetic recording medium according to claim 6, wherein the underlayer film comprises an L1₀PtMn system antiferromagnet, and the upper layer film comprises an L1₀FePt system ferromagnet.

8. The heat-assisted magnetic recording medium according to claim 6, wherein the underlayer film comprises an L1₀PtMn—Au system antiferromagnet, and the upper layer film comprises an L1₀FePt—Ni:Ag system ferromagnet.

9. The heat-assisted magnetic recording medium according to claim 6, wherein the underlayer film comprises an L1₀PtMn—Pd or L1₀PtMn—Rh system antiferromagnet, and the upper layer film comprises an L1₀FePt—Ni:Ag system ferromagnet.

10. A heat-assisted magnetic recording medium according to claim 6, wherein a layer formed by successively stacking a Ta seed layer and a Cu heat sink layer having an fcc structure is provided below the underlayer film.

11. A magnetic storage apparatus including:
a heat-assisted magnetic recording medium,
a medium driving section for driving the heat-assisted magnetic recording medium,
a magnetic head mounting a writing head and a reading head having medium heating means and recording magnetic field application means,
a magnetic head driving section for positioning the magnetic head to a desired position on the heat-assisted magnetic recording medium, and
control means, in which
the heat assist magnetic recording medium having, on a substrate, a magnetic exchange coupling film formed by stacking a lower layer film comprising an antiferromagnet at high K_{AF} of T_{B}<T_{W} and an upper layer film comprising a ferromagnet as a write/read layer at high K_{F} of T_{W}<T_{C}, the antiferromagnet is constituted so as to satisfy a relation: T_{B}<<T_{N}, and T_{B}<T_{C}<T_{N} and the coercivity H_{C} to temperature characteristic is changed stepwise with temperature T_{B} just below T_{W} by utilizing the property of T_{B} and T_{B}<<T_{N}, assuming T_{W} as a recording temperature, T_{C} as a curie temperature, T_{N} as a Neel temperature, T_{B} as a blocking temperature, K_{F} as crystal magnetic anisotropy energy constant of the ferromagnet, and K_{AF} as crystal magnetic anisotropy energy constant of the antiferromagnet, and
the control means controls T_{W} upon writing on the heat-assisted magnetic recording medium to a temperature range of: T_{B}<T_{W}<T_{C}<T_{N}.
